(19) United States
(12) Patent Application Publication
(10) Pub. No.: US 2005/0073990 A1
(43) Pub. Date: Apr. 7, 2005

(54) System and method of providing BCMCS service at a handoff in a mobile communication system

(76) Inventors: Yong Chang, Seongnam-si (KR); Nae-Hyun Lim, Seoul (KR); Jun-Hyuk Song, Anyang-si (KR); Ji-Hae Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/936,730

(22) Filed: Sep. 9, 2004

(30) Foreign Application Priority Data
Sep. 9, 2003 (KR) 2003-63424

(51) Int. Cl. H04J 3/24; H04L 12/66; H04J 3/12

(52) U.S. Cl. 370/349; 370/352

(57) ABSTRACT

A system and method providing a BCMCS service at a handoff in a mobile communication system is provided. The mobile communication system includes an AT for receiving a BCMCS service, a source AN for providing the BCMCS service to the AT, and a PCF connected to a plurality of ANs, for constructing broadcasting BCMCS service data received from a higher-layer network in the form of packet data, and providing the packet data to a predetermined AN connected to the PCF. To implement a handoff for the AT, the PCF checks, upon receipt of a handoff request message from the AT through the source AN, the ID of a target AN and the ID of the BCMCS service set in the handoff request message, and sets up a BCMCS bearer for the BCMCS service with the target AN, if the target AN is one of the ANs connected to the PCF.

### PRIORITY

This application claims the benefit under 35 U.S.C. § 119 of an application entitled “Method of Providing BCMCS Service at Handoff in a Mobile Communication System” filed in the Korean Intellectual Property Office on Sep. 9, 2003 and assigned Ser. No. 2003-63424, the entire contents of which are incorporated herein by reference.

### BACKGROUND OF THE INVENTION

1. Field of the Invention

The present invention relates generally to a method of providing a Broadcast/Multicast Service (BCMCS) service in a mobile communication system. In particular, the present invention relates to a method of providing a BCMCS service at a handoff.

2. Description of the Related Art

Mobile communication systems were developed to provide voice service, guaranteeing the mobility of users. Rapid technological development and increasing user demands were the driving force for provisioning numerous services in many fields. Among them, are e-mail, Internet service, and broadcasting service as well as basic short message service (SMS). To provide the services, a synchronous Code Division Multiple Access (CDMA) system has evolved into IS-95. Since then, CDMA-2000 has emerged and is now in commercial use. Also, an Evolution-Data Only (1×EV-DO) system dedicated for high-speed data transmission was proposed and much of a Evolution-Data and Voice (1×EV-DV) system has undergone considerable standardization for simultaneous provisioning of high-speed data transmission and voice communication.

Since the CDMA system is basically synchronous, the network is synchronized. For a BCMCS service in the mobile communication system, however, the network synchronization does not suffice because the BCMCS service is provided not over the airwaves but through interworking between the mobile communication system and particular contents servers. FIG. 1 provides a description of the network configuration and operation of a system capable of providing a BCMCS service. CDMA 1×EV-DO is taken as an example among other systems supporting a BCMCS service such as CDMA-2000 and CDMA 1×EV-DV.

Referring to FIG. 1, a BCMCS contents server (CS) 110 provides video and audio data for a BCMCS service. It generates broadcasting data in compressed Internet Protocol (IP) packets and transmits them to access networks (ANs) 160a and 160b over a packet communication network such as the Internet. The ANs 160a and 160b each include access network transceiver subsystems (ANTSs) 162a and 162b or 162c and 162d, and an access network controller (ANC) 161a or 161b. The packet communication network comprises a packet data serving node (PDSN) 140 and packet control functions (PCFs) 150a and 150b. The PDSN 140 manages user profiles and provides the BCMCS service to an access terminal (AT) 170.

The PDSN 140 is connected to an Access Network (AN) Authentication, Authorization and Accounting (AAA) server 180 for authenticating the AT 170 and an AAA server 130 for charging and broadcasting-authenticating the AT 170.

A BCMCS controller 120, connected to the BCMCS CS 110, controls communications between the BCMCS CS 110 and the AN 170 and partially performs the functions of an air interface and a radio access network (RAN) for the BCMCS service. While only one BCMCS CS 110 is shown for illustrative purposes to aid in understanding the present invention, a plurality of BCMCS CSs 110 can be connected to the BCMCS controller 120, in practice.

The BCMCS CS 110 delivers the broadcasting data to the PDSN 140 by IP multicast, and the PDSN 140 delivers it to the ANs 160a and 160b by conventional CDMA-2000 access network technology. The PDSN 140 forms multicast groups that receive IP multicast data from the BCMCS CS 110.

The IP data inclusive of video and audio data from the BCMCS CS 110 is broadcast to PDSNs 140 or unicast to the individual PDSNs 140. Each PDSN 140 relays the IP data to the ANs 160a and 160b. The ANTSs 162a to 162d convert the IP data to Radio Frequency (RF) signals and transmit them to predetermined service areas.

The BCMCS service is enabled by the above configuration of the mobile communication system. However, no regard has been given to mobility in providing the BCMCS service in the mobile communication system. That is, every cell and every AN provides the same BCMCS content. Consequently, a radio channel is opened even for a cell without any AT, thereby causing a waste of resources. To solve this problem, an AT should perform set maintenance by measuring the pilot strengths of ANs having the neighboring pilot Pseudorandom Noise (PN) offsets listed in a neighbor list.

In the typical set maintenance procedure, the AT includes an AN that transmits a pilot signal of a strength equal to or greater than a predetermined threshold T_ADD in its active set and only the active AN can provide the BCMCS service to the AT. However, within the same PCF, an AN is not allowed to provide the BCMCS contents when its pilot strength does not exceed T_ADD. Therefore, only ANs managing cells having signal strengths equal to or exceeding the predetermined value are allowed to provide the BCMCS contents, thereby preventing unnecessary resource consumption.

When the pilot strength of a source AN in the active set drops below T_DROP or the pilot strength of a neighboring AN is equal to or greater than T_ADD, the AT transmits a Pilot Strength Measurement Message (PSMM) to the source AN. The source AN determines whether to a handoff and transmits a Handoff Direction Message (HDM) to the AT, when entering into a handoff procedure.

The handoff is a procedure for continuing a call between an AT and ANs without interruptions when the AT moves between ANs within the same PCF or sharing the same frequency assignment. It is very significant to ensure seamless provisioning of BCMCS contents from a plurality of ANs at a handoff.

In the case where the BCMCS contents are nonexistent in an AN managing a neighboring cell, after the AT moves to the cell, it transmits a registration message in the cell and performs a new BCMCS service setup procedure. In this context, there is a need for a method of guaranteeing seamless BCMCS service.

### SUMMARY OF THE INVENTION

An object of the present invention is to substantially solve at least the above problems and disadvantages and to provide at least the advantages below. Accordingly, an object of the present invention is to provide a system and method of ensuring seamless reception of an on-going Broadcast/Multicast Service (BCMCS) service for a mobile terminal at a soft handoff.

Another object of the present invention is to provide a system and method of allowing a mobile terminal to receive an on-going BCMCS service at a soft handoff automatically without any particular procedure.

A further object of the present invention is to provide a system and method of guaranteeing good quality of service (QoS) for a mobile terminal which receives the same BCMCS contents simultaneously from a plurality of cells at a handoff.

The above objects are achieved by providing a system and method providing a BCMCS service at a handoff in a mobile communication system.

According to an aspect of the present invention, in a mobile communication system including an Access Terminal (AT) for receiving a BCMCS service, a source Access Network (AN) for providing the BCMCS service to the AT, and a Packet Control Function (PCF) connected to a plurality of ANs, for constructing broadcasting BCMCS service data received from a higher-layer network in the form of packet data, and providing the packet data to a predetermined AN connected to the PCF, to implement a handoff for the AT, the PCF checks, upon receipt of a handoff request message from the AT through the source AN, the ID of a target AN and the ID of the BCMCS service set in the handoff request message, and sets up a BCMCS bearer for the BCMCS service with the target AN, if the target AN is one of the ANs connected to the PCF.

According to another aspect of the present invention, in a mobile communication system including an AT for receiving a BCMCS service, a source AN for providing the BCMCS service to the AT, and a PCF connected to a plurality of ANs, for constructing broadcasting BCMCS service data received from a higher-layer network in the form of packet data, and providing the packet data to a predetermined AN connected to the PCF, to implement a handoff for the AT, the AT detects a target AN that transmits a signal with a strength equal to or greater than a threshold and transmits to the source AN a handoff request message including the ID of the target AN and the ID of the BCMCS service, the source AN transmits the handoff request message to the PCF, and the PCF sets up a BCMCS bearer for the BCMCS service with the target AN, if the target AN is one of the ANs connected to the PCF.

According to a further aspect of the present invention, in a mobile communication system including an AT for receiving a BCMCS service, a source AN for providing the BCMCS service to the AT, a source PCF connected to a plurality of ANs including the source AN, for providing the BCMCS service to a predetermined AN connected to the source PCF, and a PDSN connected to a plurality of PCFs, for constructing BCMCS service data received from a higher-layer broadcasting network in the form of packet data and providing the packet data to a predetermined PCF connected to the PDSN, to implement a handoff for the AT, the PDSN checks, upon receipt of a handoff request message from the source PCF, the ID of a target AN and the ID of the BCMCS service set in the handoff request message, and transmits, if the target AN is connected to a target PCF different from the source PCF, a connection request message to the target PCF.

According to still another aspect of the present invention, in a mobile communication system including an AT for receiving a BCMCS service, a source AN for providing the BCMCS service to the AT, a source PCF connected to a plurality of ANs including the source AN, for providing the BCMCS service to a predetermined AN connected to the source PCF, and a PDSN connected to a plurality of PCFs, for constructing BCMCS service data received from a higher-layer broadcasting network in the form of packet data and providing the packet data to a predetermined PCF connected to the PDSN, to implement a handoff for the AT, the AT detects a target AN that transmits a signal with a strength equal to or greater than a threshold and transmitting to the source AN a handoff request message including the ID of the target AN and the ID of the BCMCS service The source AN transmits the handoff request message to the source PCF, and the source PCF transmits, if the target AN is not one of the ANs connected to the source PCF, the handoff request message to the PDSN. The PDSN transmits to a target PCF connected to the target AN a connection request message for connection to the target AN, and sets up a BCMCS bearer for the BCMCS service with target AN.

According to yet another aspect of the present invention, in a mobile communication system including an AT for receiving a BCMCS service, a source AN for providing the BCMCS service to the AT, a PCF connected to a plurality of ANs, for providing the BCMCS service to a predetermined AN connected to the source PCF, and a PDSN connected to a plurality of PCFs, for constructing BCMCS service data received from a higher-layer broadcasting network in the form of packet data and providing the packet data to a predetermined PCF connected to the PDSN, to implement a handoff for the AT, the AT detects a target AN that transmits a signal with a strength equal to or greater than a threshold and transmits to the source AN a handoff request message including the ID of the target AN and the ID of the BCMCS service. The source AN transmits the handoff request message to a source PCF connected to the source AN. If the target AN is not one of the ANs connected to the source PCF, the source PCF transmits the handoff request message to a target PCF connected to the target AN. The target PCF requests a BCMCS service registration to the PDSN and sets up a BCMCS bearer for the BCMCS service with the target AN.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating the configuration of a mobile communication system that provides a Broadcast/Multicast Service (BCMCS) service;

FIGS. 2A, 2B and 2C are diagrams illustrating signal flows for providing a BCMCS service at a handoff according to an embodiment of the present invention;

FIGS. 3A, 3B and 3C are diagrams illustrating signal flows for providing a BCMCS service at a handoff according to another embodiment of the present invention;

FIGS. 4A, 4B and 4C are diagrams illustrating signal flows for providing a BCMCS service at a handoff according to a third embodiment of the present invention;

FIG. 5A is a diagram illustrating the format of an A9-BCMCS Request-A8 message transmitted in step 230 of FIG. 2B, step 330 of FIG. 3B, and step 430 of FIG. 4B;

FIGS. 5B to 5K are diagrams illustrating the fields of the A9-BCMCS Request-A8 message illustrated in FIG. 5A;

FIG. 6A is a diagram illustrating the format of an A9-BCMCS Request-A8-Ack message transmitted in step 235 of FIG. 2B, step 335 of FIG. 3B, and step 435 of FIG. 4B;

FIGS. 6B to 6F are diagrams illustrating the fields of the A9-BCMCS Request-A8 Ack message illustrated in FIG. 6A;

FIG. 7 is a diagram illustrating the format of an A9-BCMCS Setup Request-A8 message transmitted in step 260 of FIG. 2B, step 360 of FIG. 3B, and step 460 of FIG. 4B;

FIG. 8 is a diagram illustrating the format of an A9-BCMCS Setup Request-A8 Ack message transmitted in step 265 of FIG. 2B, step 365 of FIG. 3B, and step 465 of FIG. 4B;

FIG. 9A is a diagram illustrating the format of an A11-BCMCS Connect message transmitted in step 350 of FIG. 3B;

FIGS. 9B to 9M are diagrams illustrating the fields of the A11-BCMCS Connect message illustrated in FIG. 9A;

FIG. 10 is a diagram illustrating the format of an A11-BCMCS Connect Ack message transmitted in step 355 of FIG. 3B;

FIG. 11A is a diagram illustrating the format of an A13-BCMCS Connect Request message transmitted in step 440 of FIG. 4B;

FIGS. 11B to 11I are diagrams illustrating the fields of the A13-BCMCS Connect Request message illustrated in FIG. 11A;

FIG. 12A is a diagram illustrating the format of an A13-BCMCS Connect Request Ack message transmitted in step 445 of FIG. 4B; and

FIGS. 12B to 12G are diagrams illustrating the fields of the A13-BCMCS Connect Request Ack message illustrated in FIG. 12A.

Throughout the drawings, it should be noted that the same or similar elements are denoted by like reference numerals.

### DETAILED DESCRIPTION OF THE PREFERRED EMBODIMENTS

Embodiments of the present invention will now be described herein below with reference to the accompanying drawings. In the following description, well-known functions or constructions are not described in detail for conciseness.

In accordance with embodiments of the present invention, an Access Terminal (AT), rather than transmit a handoff request message to a target Access Network (AN) (T_AN) after a handoff, measures the strengths of pilot signals from ANs included in a neighbor list before the handoff, detects the _AN having a pilot strength equal to or higher than a threshold, and then transmits the handoff request message to a source AN (S_AN) now providing a Broadcast/Multicast Service (BCMCS) service to the AT where it is located, so that the T_AN can set up a BCMCS bearer to provide the on-going BCMCS service to the AT.

The present invention is implemented in different embodiments depending on whether the S_AN and the T_AN are under the control of the same Packet Control Functions (PCF) or different PCFs.

When the same PCF works for the S_AN and the T_AN, the S_AN reports to the PCG information about the on-going BCMCS contents and a neighbor AN list, before a handoff. The PCF then provides the BCMCS contents information to the T_AN so that the T_AN sets up a bearer for transmission of the BCMCS contents before the handoff.

When different PCFs work for the S_AN and the T_AN, a source PCF (S_PCF) managing the S_AN reports the BCMCS contents information and the neighbor AN list to a Packet Data Serving Node (PDSN). The PDSN provides the BCMCS contents information to a target PCF (T_PCF) managing the T_AN so that the T_PCF sets up a bearer for transmission of the BCMCS contents beforehand.

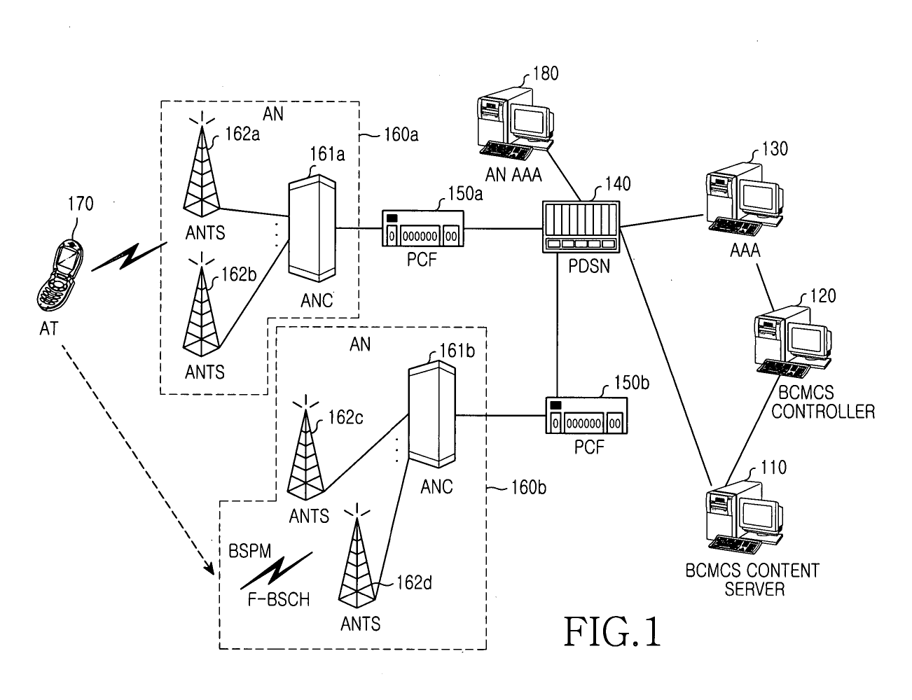

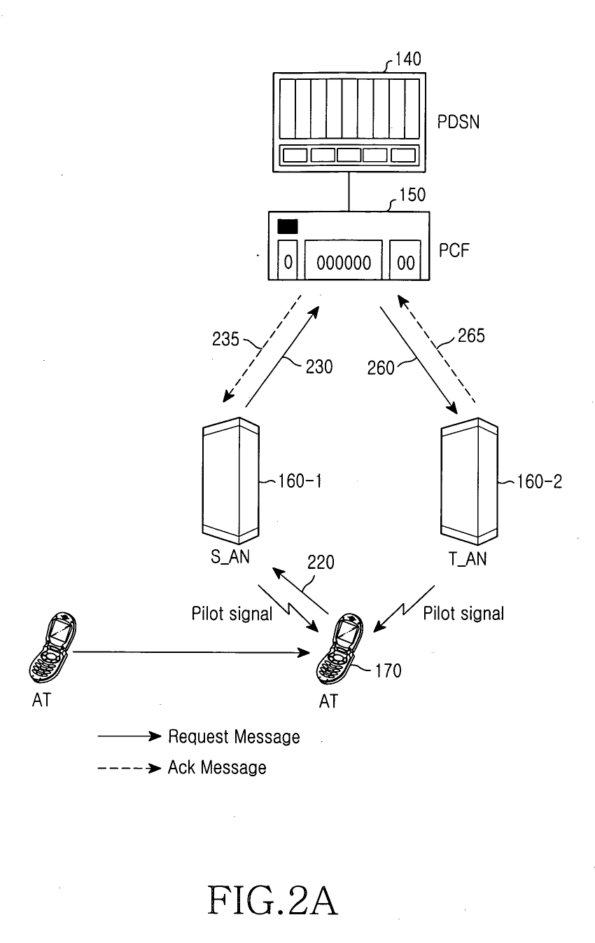

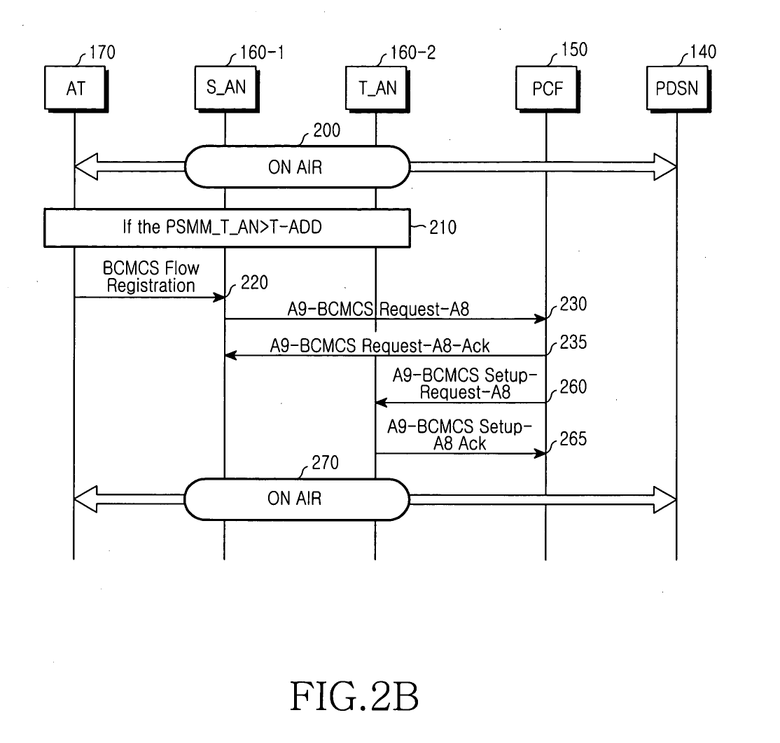

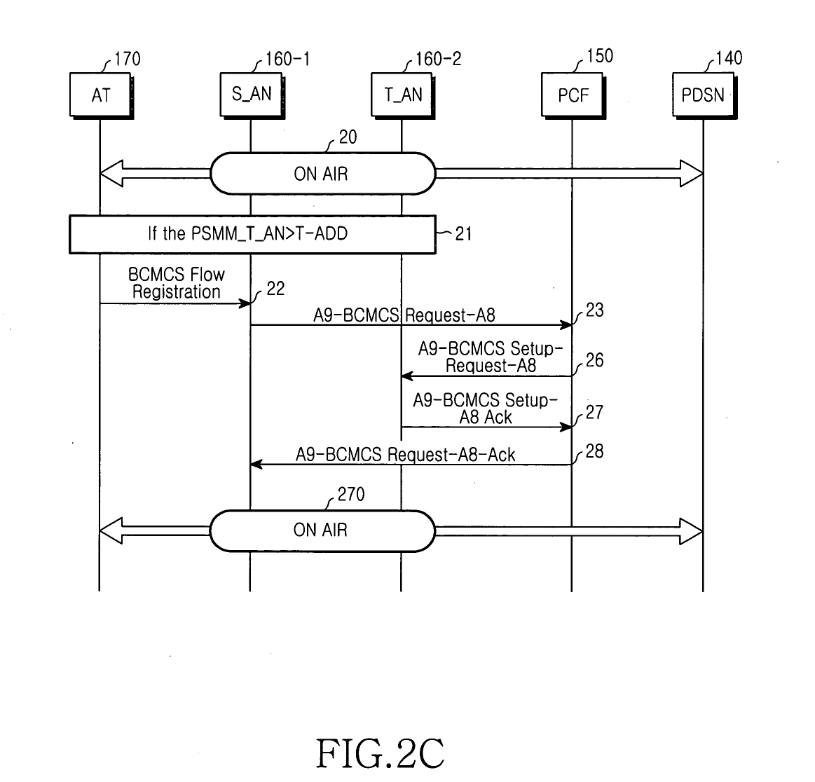

A method of providing a BCMCS service at a handoff between ANs under the same PCF (hereinafter, referred to as an intra-PCF handoff) will first be described with reference to FIGS. 2A, 2B and 2C. Referring to FIG. 2A, the AT 170 is receiving a BCMCS service. The condition of receiving the BCMCS service and a flow of transmission of BCMCS data will now be described. The AT 170 selects an AN that transmits a pilot signal with the highest strength among ANs in its active set and receives the BCMCS service from the selected AN. This AN is a S_AN. Reference numeral 160-1 denotes the S_AN in FIG. 2A. The S_AN 160-1 is connected to a PCF 150. The PCF 150 includes the S_AN 160-1 and other underlying ANs. For notational simplicity, only the S_AN 160-1 and a T_AN 160-2 are illustrated in FIG. 2A. A data flow between the T_AN 160-2 and the S_AN 160-1 will be detailed with reference to FIG. 2B. There is a higher-layer network such as a PDSN 140 from which the PCF 150 receives the BCMCS service. Higher-layer devices of the PCF 150 are configured as illustrated in FIG. 1, though the actual implementation of the higher-layer devices obviously depends on the network configuration. The network configuration will not be described herein and all nodes overlying the PCF 150, for providing the BCMCS service are collectively called “a higher-layer network”.

Referring to FIG. 2B, the AT 170 receives BCMCS contents from a BCMCS CS via the S_AN 160-1, the PCF 150, and the PDSN 140 in step 200. The S_AN 160-1 is included in an active set having pilot strengths equal to or higher than a threshold T_ADD. During the BCMCS service in progress from the S_AN 160-1, the AT 170 manages the active set by continuously receiving pilot signals from neighboring ANs not included in the active set. In step 210, the AT 170 detects that a T_AN 160-2 not included in the active set has a pilot strength equal to or greater than T_ADD and notifies the S_AN 160-1 of the pilot signal strength of the T_An 160-2 by a Pilot Strength Measurement Message (PSMM).

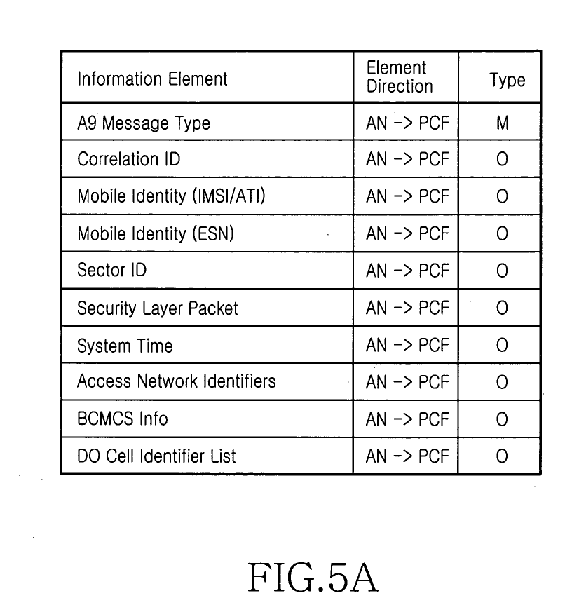

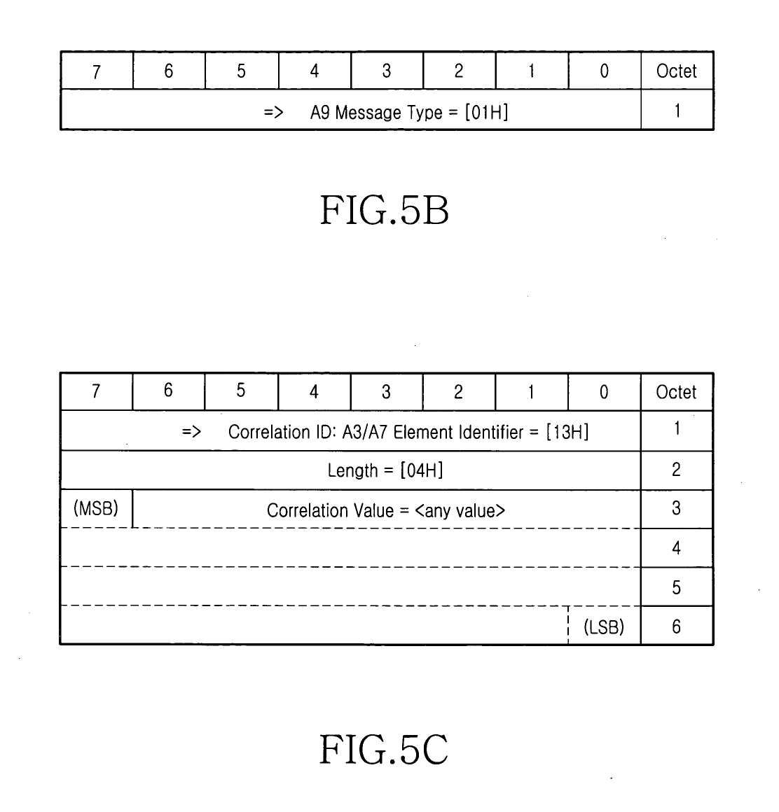

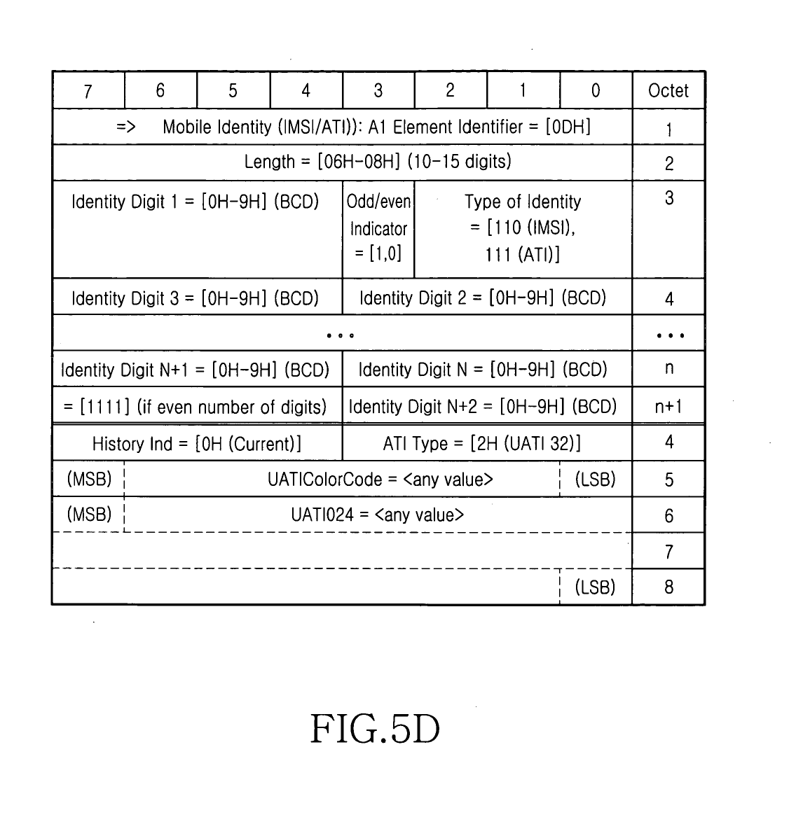

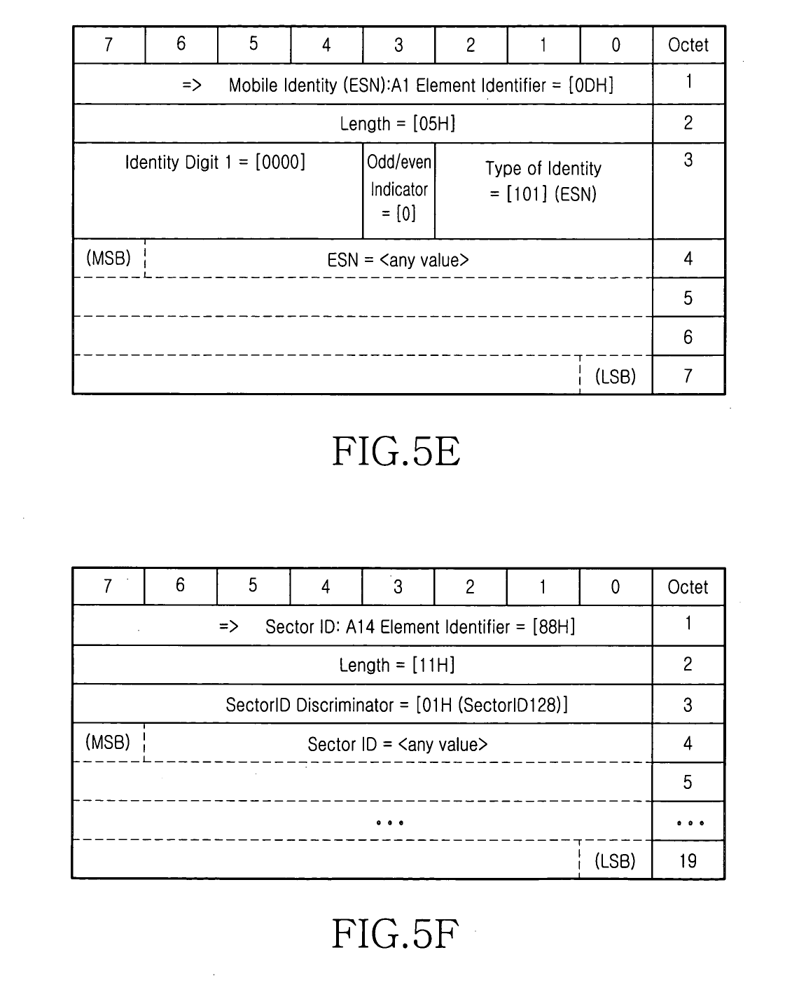

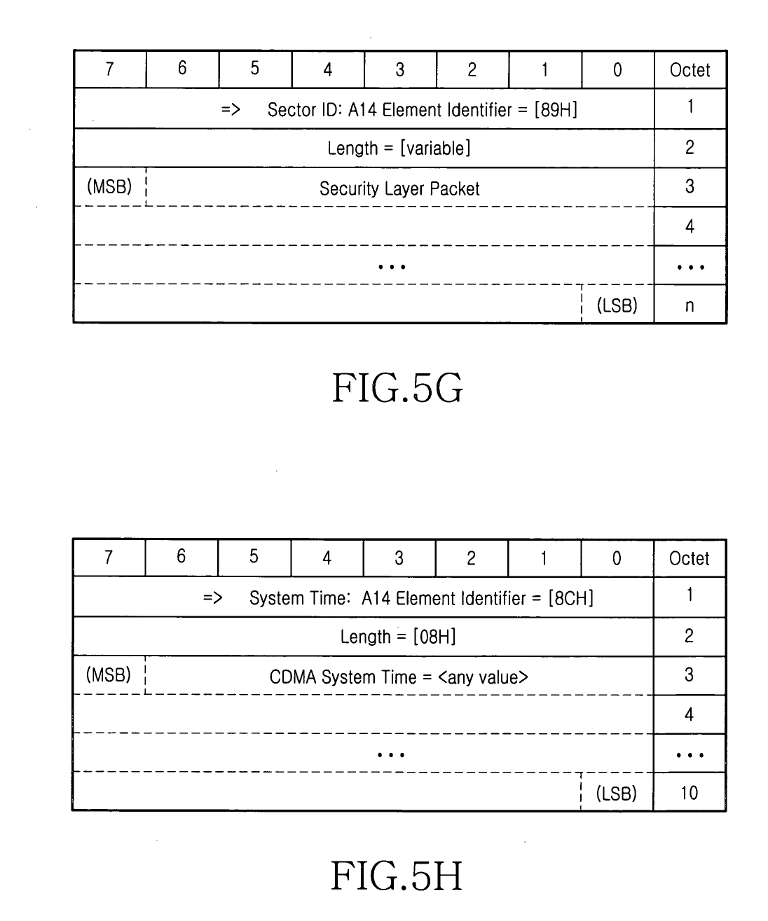

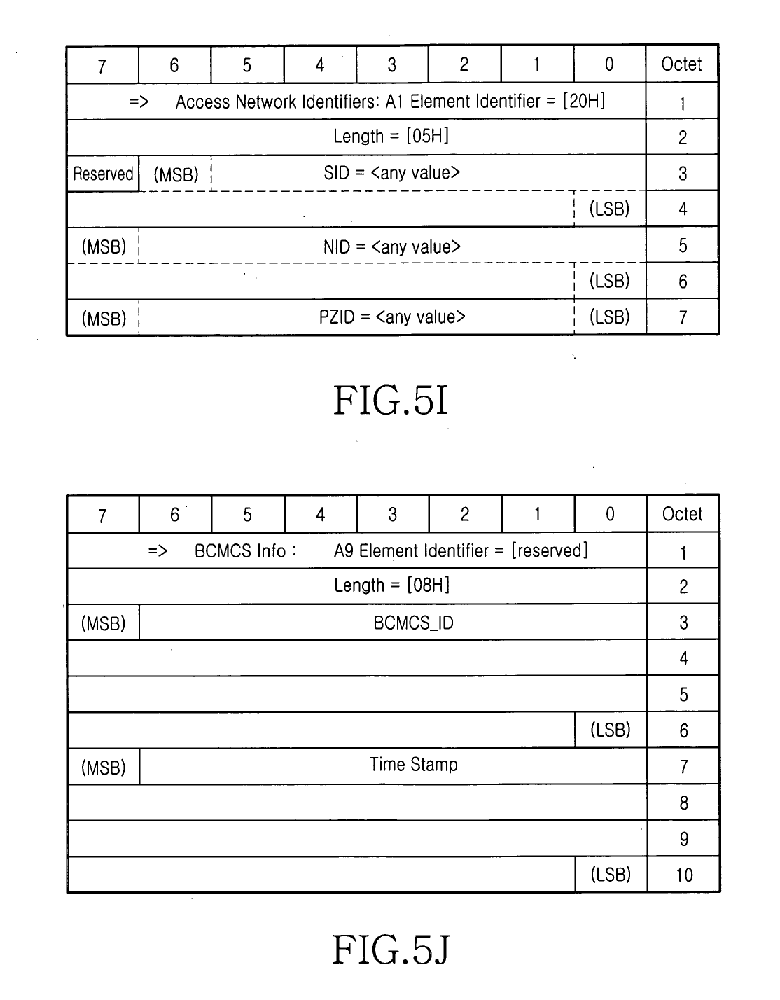

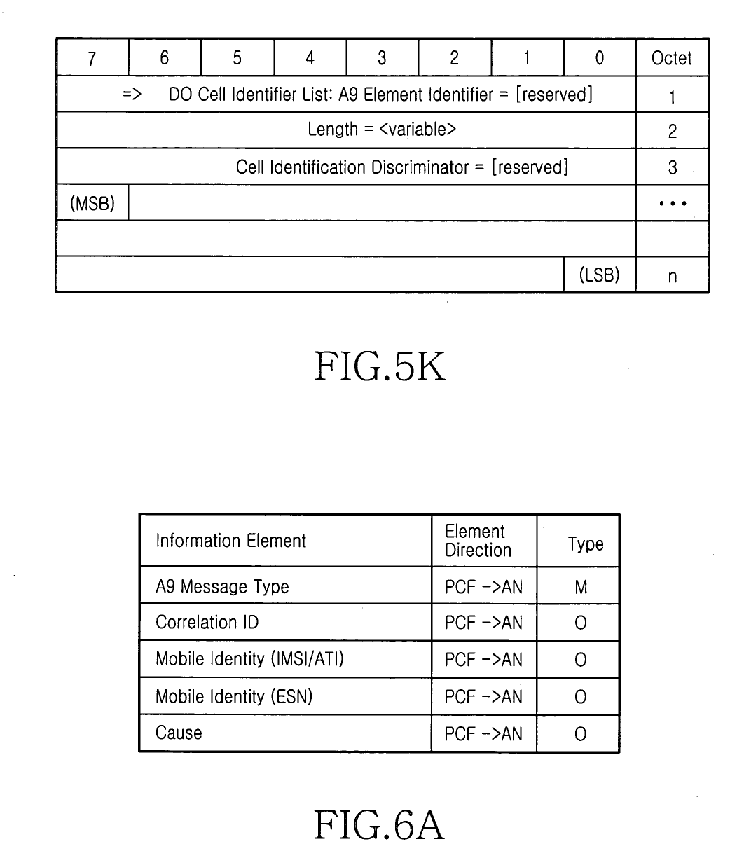

In step 220, the AT 170 transmits a BCMCS Flow Registration message to the S_AN 160-1. The BCMCS Flow Registration message requests activation of the BCMCS contents delivery function of the T_AN 160-2 to the AT 170 in order to allow the AT 170 to receive the BCMCS service quickly at a handoff that may occur. The S_AN 160-1 transmits an A9-BCMCS Request-A8 message to the PCF 150, requesting provisioning of the BCMCS service to the T_AN 160-2 in step 230. An example of the A9-BCMCS Request-A8 message is illustrated in FIG. 5A and will be described later.

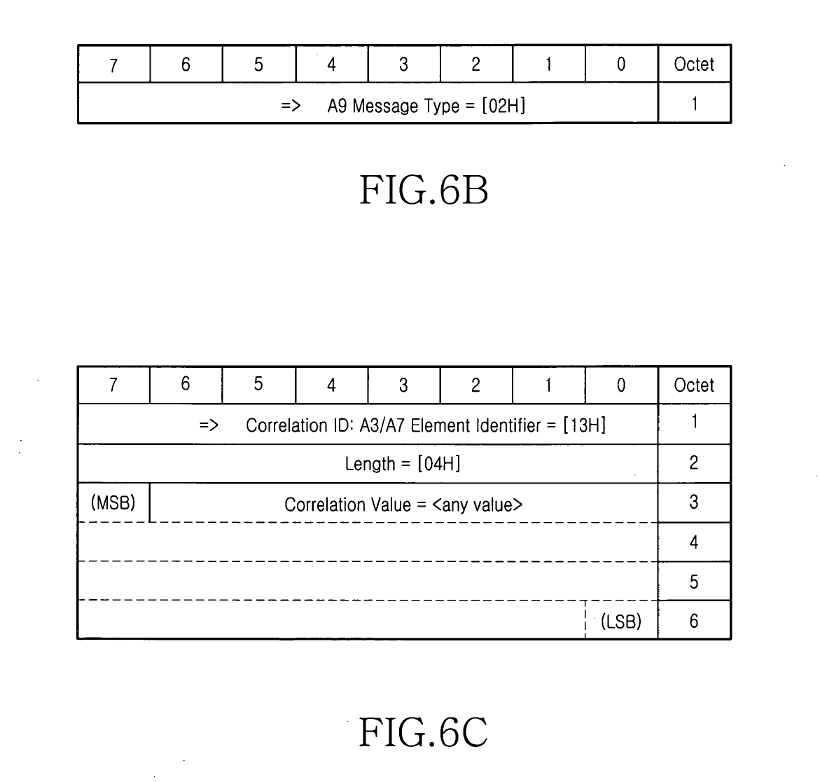

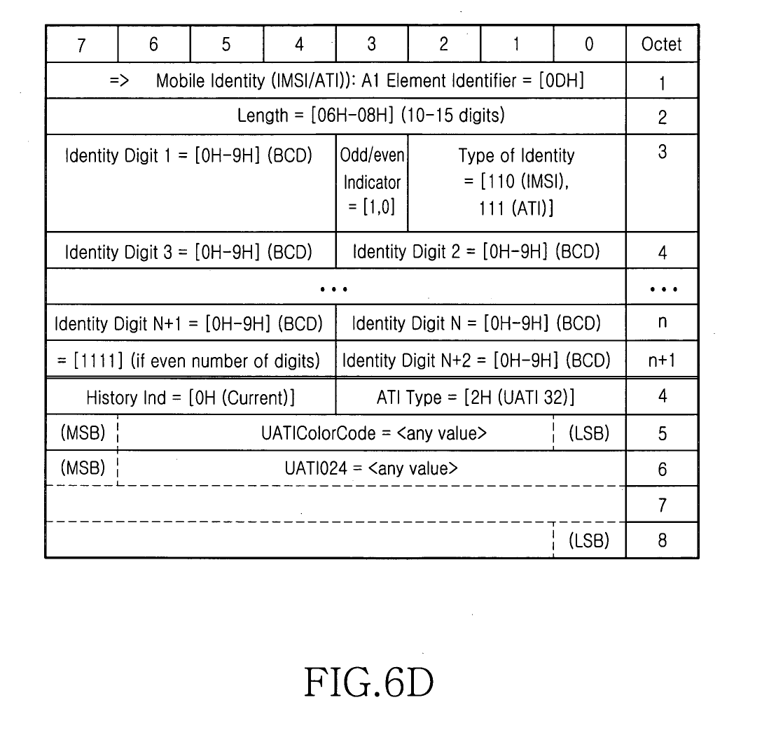

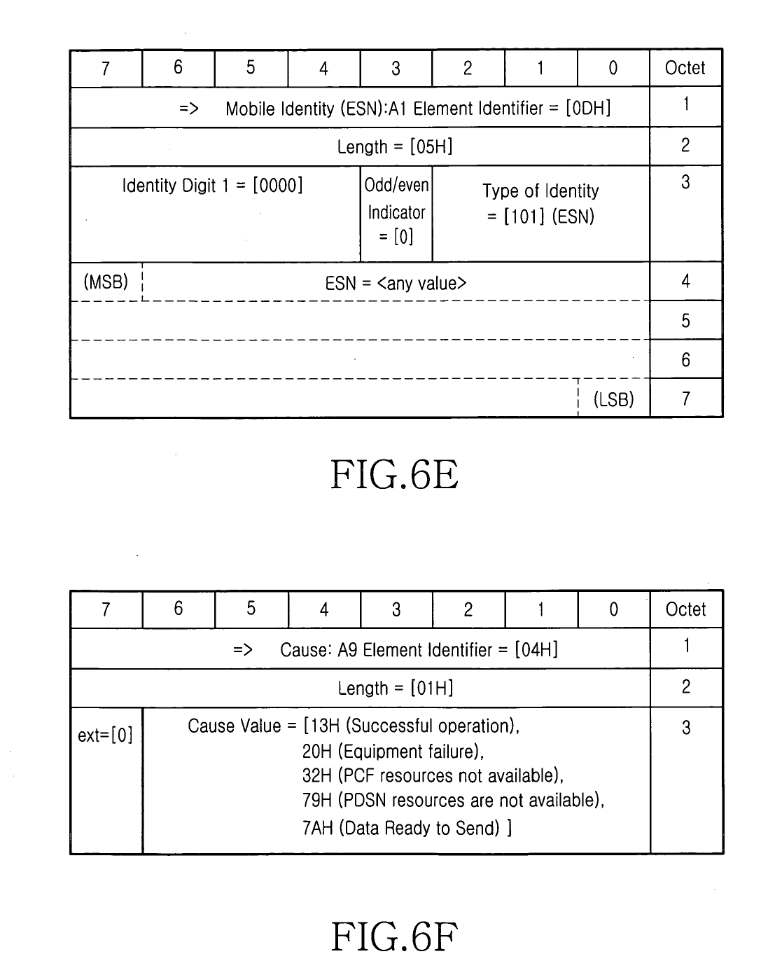

In step 235, the PCF 150 transmits to the S_AN 160-1 an A9-BCMCS Request-A8 Ack message indicating successful reception of the A9-BCMCS Request-A8 message. An example of the A9-BCMCS Request-A8 Ack message is illustrated in FIG. 6A and will be described later.

The PCF 150 transmits an A9-BCMCS Setup Request-A8 message to the T_AN 160-2, requesting setup of an A8 connection in step 260. In step 265, the T_AN 160-2 transmits an A9-BCMCS Setup Request-A8 Ack message for the A9-BCMCS Setup Request-A8 message to the PCF 150.

The AT 170 receives the BCMCS service simply by registering intended BCMCS contents in step 270.

In the procedure of FIG. 2B, upon receipt of the A9-BCMCS Request-A8 message from the S_AN 160-1, the PCF 150 transmits the A9-BCMCS-A8 Ack message as a response message to the S_AN 160-1 and then transmits the A9-BCMCS Setup-Request-A8 message to the T_AN 160-2 in step 260. That is, after a response message for a request message is generated, another request message is transmitted.

FIG. 2C is a diagram illustrating a signal flow in which after all request messages are generated, response messages are generated in the reverse direction of the request messages, compared to the signal flow in FIG. 2B. Referring to FIG. 2C, upon receipt of the BCMCS Flow Registration message, the S_AN 160-1 transmits the A9-BCMCS Request-A8 message to the PCF 150 in step 23. An example of the A9-BCMCS Request-A8 message is illustrated in FIG. 5A.

In step 26, the PCF 150 transmits to the T_AN 160-2 the A9-BCMCS Setup Request-A8 message requesting an A8 connection. The T_AN 160-2 transmits the A9-BCMCS Setup-A8 Ack message for the A9-BCMCS Setup Request-A8 message to the PCF 150 in step 27. In step 28, the PCF 150 transmits to the S_AN 160-1 the A9-BCMCS Setup Request-A8 message to the T_AN 160-2, indicating successful reception of the A9-BCMCS Request-A8 message. An example of the A9-BCMCS Request-A8 Ack message is illustrated in FIG. 6A.

The AT 170 receives the BCMCS service simply by registering intended BCMCS contents in step 270.

A method of providing a BCMCS service at a handoff between ANs under different PCFs (hereinafter, referred to as an inter-PCF handoff) according to another embodiment of the present invention will now be described.

At the inter-PCF handoff, the BCMCS service function of the T_AN can be activated in two embodiments.

One is to transmit a handoff request message to the PDSN by the S_PCF. The other is to transmit a BCMS connection request message to the T_PCF by the S_PCF so that the T_PCF transmits a handoff request message directly to the PDSN. The former embodiment is applicable commonly to both 1× and First Evolution-Data Only (1×EV-DO) systems, whereas the latter embodiment is confined to the 1×EV-DO system. It should be appreciated that provisioning of a BCMCS service at a handoff in a system having a PCF within each AN also falls into the scope of the present invention. An AN provided with a PCF performs the functions inherent to the PCF in each embodiment of the present invention which will be described below.

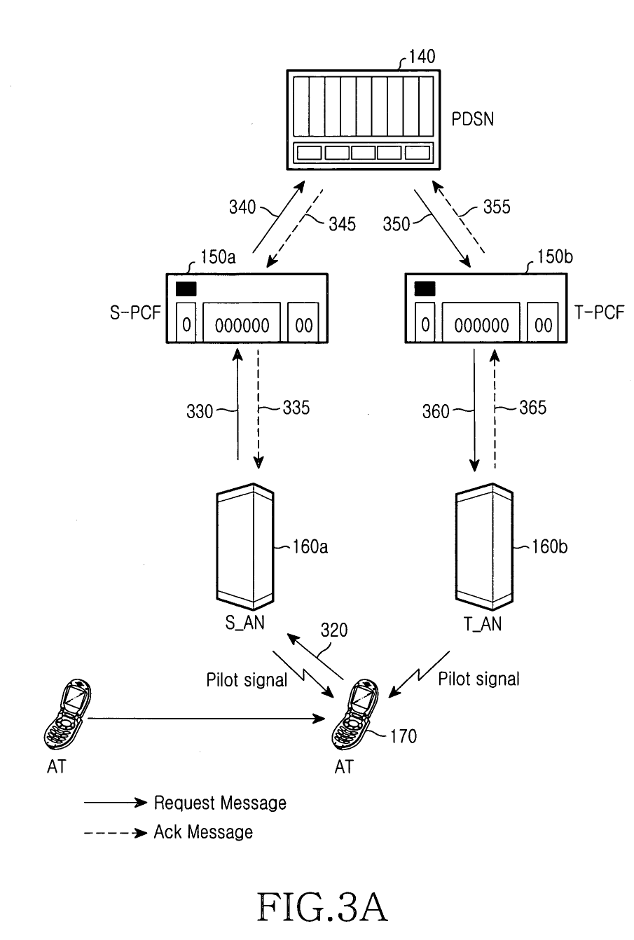

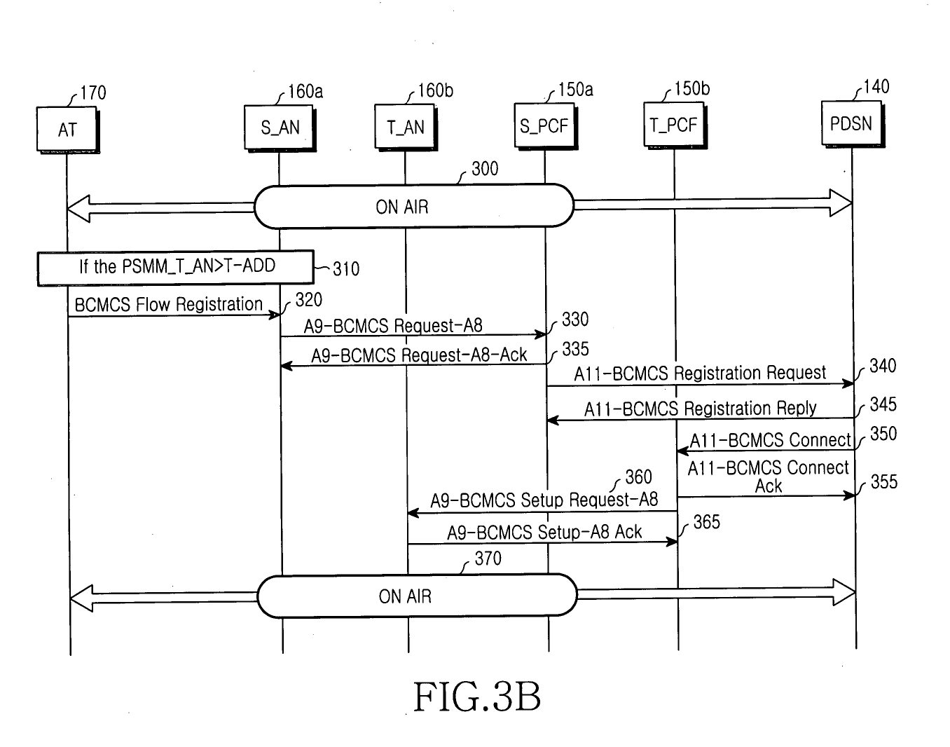

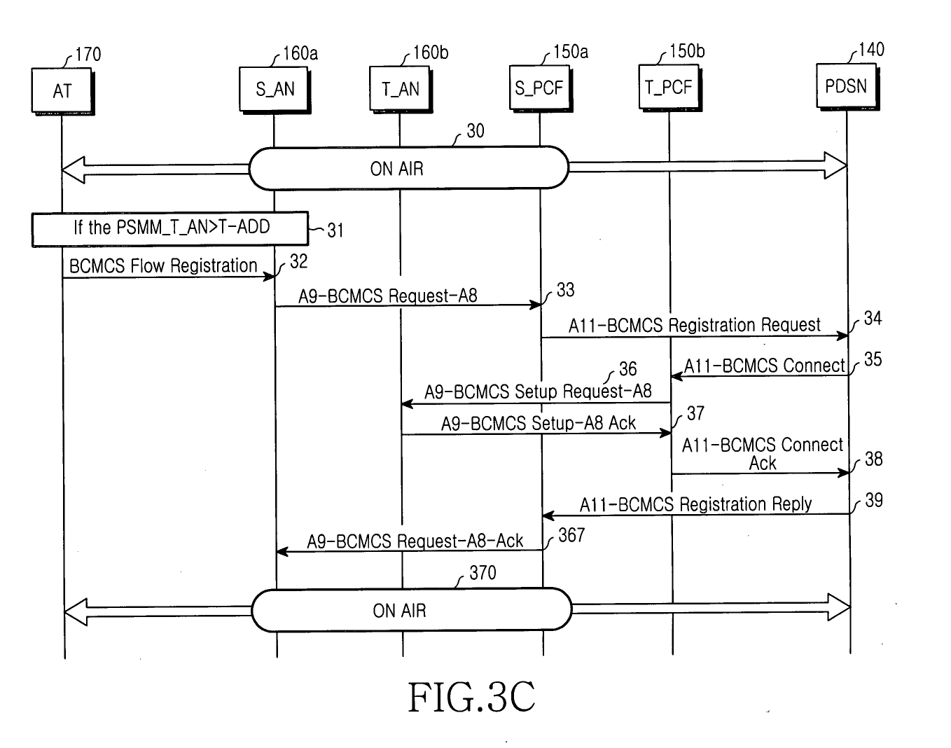

FIGS. 3A, 3B and 3C are diagrams illustrating signal flows for an embodiment of an operation for providing a BCMCS service at an inter-PCF handoff according to the present invention.

Referring to FIG. 3A, the AT 170 is receiving a BCMCS service. The condition of receiving the BCMCS service and a flow of transmission of BCMCS data will be described. The AT 170 selects an AN that transmits a pilot signal with the highest strength among ANs in its active set and receives the BCMCS service from the selected AN. This AN is an S_AN. Reference numeral 160a denotes the S_AN in FIG. 3A. A PCF 150a connected to the S_AN 160a is an S_PCF. The S_PCF 150a includes the S-AN 160a and other underlying ANs. The S_PCF 150a is connected to its overlying PDSN 140. The PDSN 140 includes the S_PCF 150a and other PCFs. For notational simplicity, only the S_AN 160a, the S_PCF 150a, a T_AN 160b, and a T_PCF 150b are illustrated in FIG. 3A. A data flow between them will be detailed with reference to FIG. 3B. Higher-layer network devices overlying the PDSN 140 are configured as illustrated in FIG. 1, though the actual implementation of the higher-layer network devices obviously depends on network configuration. The network configuration will not be described herein and all nodes overlying the PDSN 140, for providing the BCMCS service are collectively called “a higher-layer network”.

Referring to FIG. 3B, the AT 170 receives BCMCS contents from a BCMCS CS via an S_AN 160a, an S_PCF 150a, and the PDSN 140 in step 300. The S_AN 160a is included in an active set having pilot strengths equal to or higher than T_ADD. During the BCMCS service in progress from the S_AN 160a, the AT 170 manages the active set by continuously receiving pilot signals from neighboring ANs not included in the active set. In step 310, the AT 170 finds out that a T_AN 160b not included in the active set but connected to a T_PCF 150b has a pilot strength equal to or greater than T_ADD and notifies the S_AN 160a of the pilot signal strength of the T_An 160b by a PSMM.

In step 320, the AT 170 transmits a BCMCS Flow Registration message to the S_AN 160a. The BCMCS Flow Registration message requests activation of the BCMCS contents delivery function of the T_AN 160b to the AT 170 in order to allow the AT 170 to receive the BCMCS service quickly at a handoff that may occur.

The S_AN 160a transmits an A9-BCMCS Request-A8 message to the S_PCF 150a, requesting provisioning of the BCMCS service to the T_AN 160b in step 330. For the format of the A9-BCMCS Request-A8 message, see FIG. 5A.

In step 335, the S_PCF 150a transmits to the S_AN 160a an A9-BCMCS Request-A8 Ack message.

The S_PCF 150a transmits an All-BCMCS Registration Request message to the PDSN 140, requesting initiation of a connection setup between the PDSN and the T_PCF 150b in step 340. In the case where the system has a PCF within each AN, the S_AN 160a takes charge of performing step 340.

In step 345, the PDSN 140 transmits to the S_PCF 150a an A11-BCMCS Registration Reply message for the A11-BCMCS Registration Request message.

The PDSN 140 transmits an A11-BCMCS Connect message to the T_PCF 150b, requesting a connection setup in step 350. As described above, if each AN is provided with a PCF, The PDSN 140 transmits the A11-BCMCS Connect message to the T_AN 160b. In step 355, the T_PCF 150b transmits an A11-BCMCS Connect Ack message to the PDSN 140.

In step 360, the T_PCF 150b transmits an A9-BCMCS Setup Request-A8 message to the T_AN 160b, requesting a connection setup. In step 365, the T_AN 160b transmits an A9-BCMCS Setup Request-A8 Ack message for the A9-BCMCS Setup Request-A8 message to the T_PCF 150b.

In step 370, after the handoff to the T_AN 160b, the AT 170 transmits a BCMS Flow Registration message to the T_AN 160b and then receives the BCMCS contents via the already established A8/A10 connection.

FIG. 3C is a diagram illustrating a signal flow in which after all request messages are generated, response messages for them are generated in the reverse direction of the request messages, compared to the signal flow in FIG. 3B.

Referring to FIG. 3C, upon receipt of the BCMCS Flow Registration message, the S_AN 160a transmits the A9-BCMCS Request-A8 message to the S_PCF 150a, requesting provisioning of the BCMCS service to the T_AN 160b in step 33. An example of the A9-BCMCS Request-A8 message is illustrated in FIG. 5A.

In step 34, the S_PCF 150a transmits to the PDSN 140 the A11-BCMCS Registration Request message requesting a connection setup between the PDSN 140 and the T_PCF 150b. In the case where the system has a PCF within each AN, the S_AN 160a takes charge of performing step 34.

In step 35, the PDSN 140 requests a connection setup by transmitting the A11-BCMCS Connect message to the T_PCF 150b. As described above, if each AN is provided with a PCF, The PDSN 140 transmits the A11-BCMCS Connect message to the T_AN 160b. In step 36, the T_PCF 150b transmits the A9-BCMCS Setup Request-A8 message to the T_AN 160b, requesting a connection setup with the T_AN 160b. In step 37, the T_AN 160b transmits the A9-BCMCS Setup Request-A8 Ack message for the A9-BCMCS Setup Request-A8 message to the T_PCF 150b. The T_PCF 150b transmits the A11-BCMCS Connect Ack message to the PDSN 140 in step 38.

In step 39, upon receipt of the A11-BCMCS Connect Ack message, the PDSN 140 transmits the A11-BCMCS Registration Reply message to the S_PCF 150a.

The S_PCF 150a transmits the A9-BCMCS Request-A8 Ack message to the S_AN 160a in step 367.

In step 370, after the handoff to the T_AN 160b, the AT 170 transmits a BCMCS Flow Registration message to the T_AN 160b and then receives the BCMCS contents via the already established A8/A10 connection.

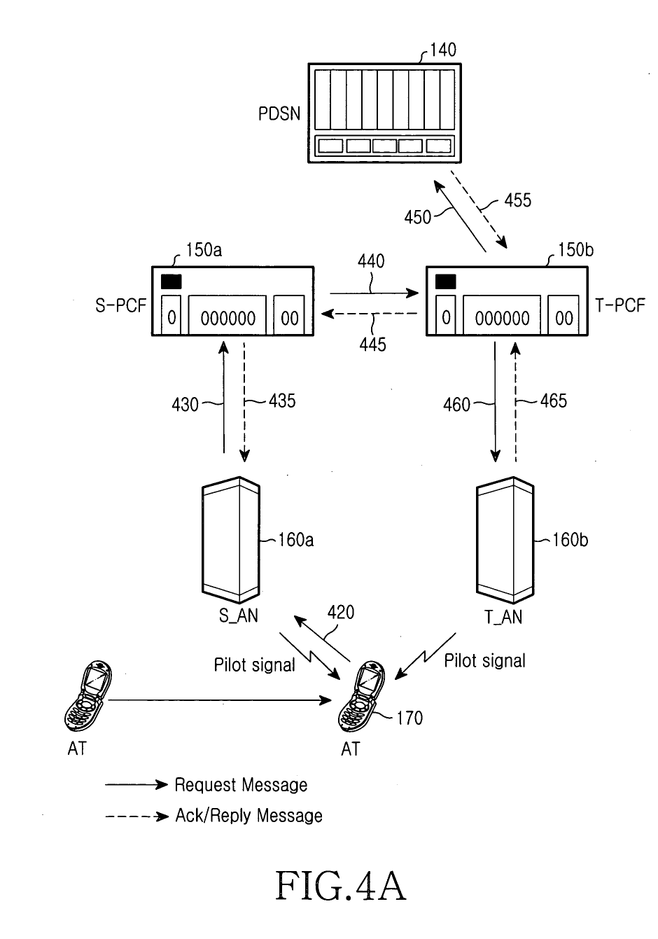

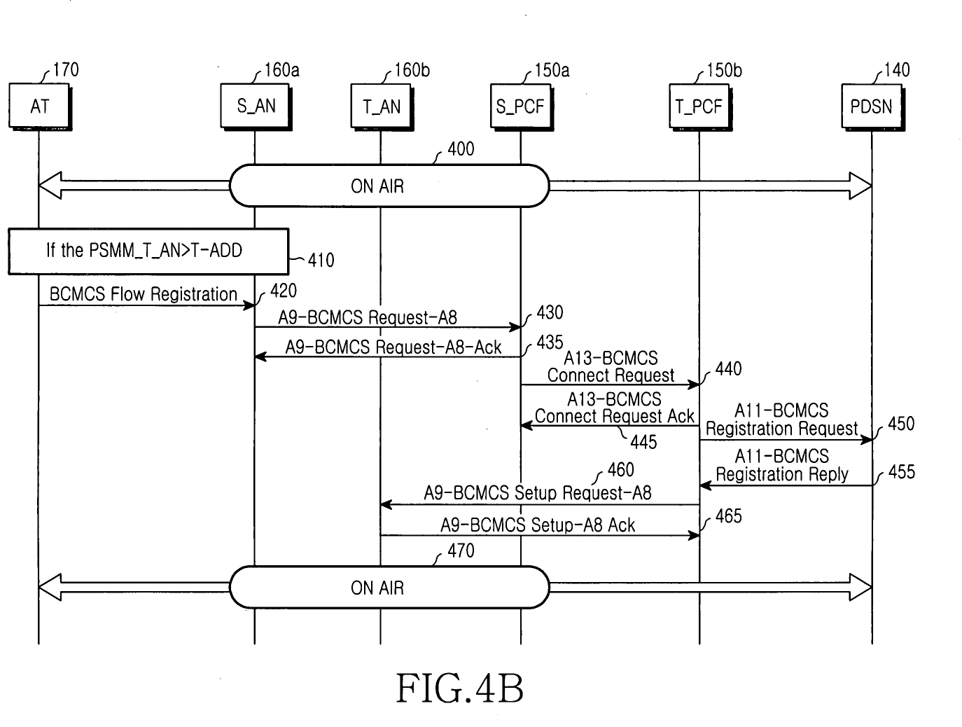

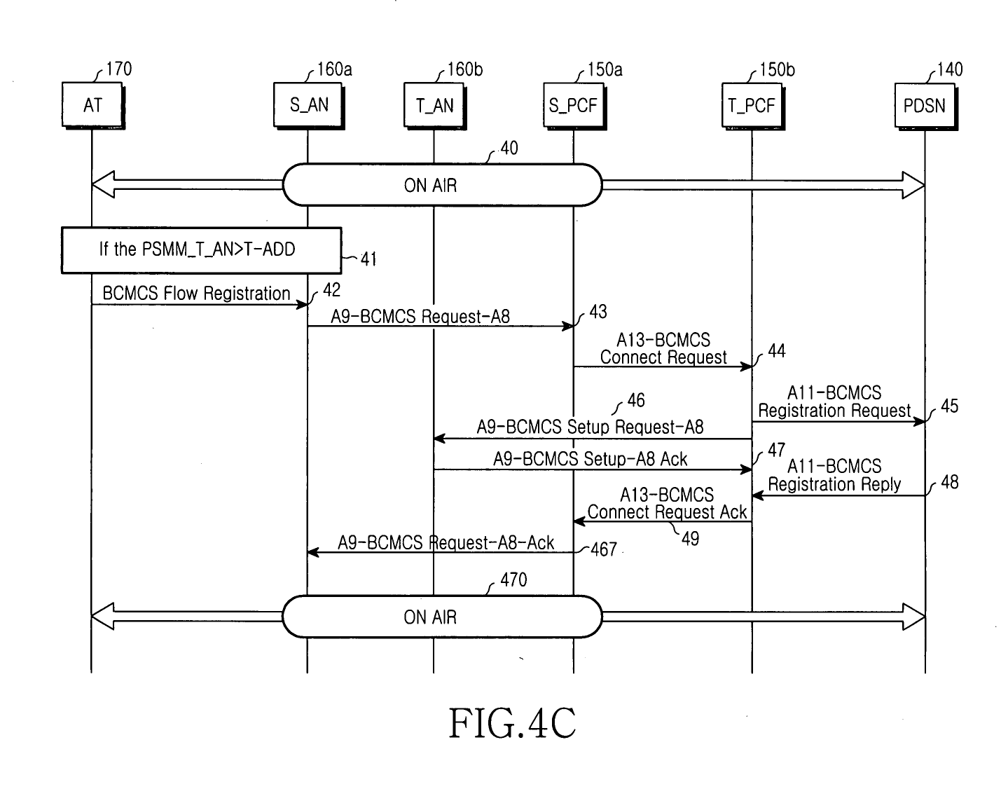

FIGS. 4A, 4B and 4C are diagrams illustrating signal flows for another embodiment of the operation for providing a BCMCS service at an inter-PCF handoff according to the present invention.

FIG. 4A will not be described in detail herein because the configuration illustrated in FIG. 4A is similar to that of FIG. 3A.

Referring to FIG. 4B, the AT 170 receives BCMCS contents from the BCMCS CS via the S_AN 160a, the S_PCF 150a, and the PDSN 140 in step 400. The S_AN 160a is included in an active set having pilot strengths equal to or higher than T_ADD. During the BCMCS service in progress from the S_AN 160a, the AT 170 manages the active set by continuously receiving pilot signals from neighboring ANs not included in the active set. In step 410, the AT 170 detects that the T_AN 160b not included in the active set but connected to the T_PCF 150b has a pilot strength equal to or greater than T_ADD and notifies the S_AN 160a of the pilot signal strength of the T_An 160b by a PSMM in step 410.

In step 420, the AT 170 transmits a BCMCS Flow Registration message to the S_AN 160a. The BCMCS Flow Registration message requests activation of the BCMCS contents delivery function of the T_AN 160b to the AT 170 in order to allow the AT 170 to receive the BCMCS service quickly at a handoff that may occur.

The S_AN 160a transmits an A9-BCMCS Request-A8 message to the S_PCF 150a in step 430. In step 435, the S_PCF 150a transmits to the S_AN 160a an A9-BCMCS Request-A8 Ack message. The S_PCF 150a transmits an A13-BCMCS Connect Request message to the T_PCF 150b, requesting a connection setup between the T_PCF 150b and the T_AN 160b in step 440. In the case where the system has a PCF within each AN, the S_AN 160a takes charge of performing step 440.

In step 445, the T_PCF 150b transmits to the S_PCF 150a an A13-BCMCS Connect Request Ack message, indicating successful reception of the A13-BCMCS Connect Request message.

The T_PCF 150b transmits an A11-BCMCS Registration Request message to the PDSN 140, requesting a connection setup in step 450. As described above, if each AN is provided with a PCF, the T_AN 160b transmits the A11-BCMCS Registration Request message to the PDSN 140. In step 455, the PDSN 140 transmits an A11-BCMCS Registration Reply message to the T_PCF 150b, indicating successful reception of A11-BCMCS Registration Request message.

In step 460, the T_PCF 150b transmits an A9-BCMCS Setup Request-A8 message to the T_AN 160b, requesting a connection setup. In step 465, the T_AN 160b transmits an A9-BCMCS Setup Request-A8 Ack message for the A9-BCMCS Setup Request-A8 message to the T_PCF 150b.

In step 470, the AT 170 transmits a BCMCS Flow Registration message to the T_AN 160b and then receives the BCMCS contents via the already established A8/A10 connection.

FIG. 4C is a diagram illustrating a signal flow in which after all request messages are generated, response messages for them are generated in the reverse direction of the request messages, compared to the signal flow in FIG. 4B.

Referring to FIG. 4C, upon receipt of the BCMCS Flow Registration message, the S_AN 160a transmits the A9-BCMCS Request-A8 message to the S_PCF 150a in step 43. In step 44, the S_PCF 150a transmits the A13-BCMCS Connect Request message to the T_PCF 150b, requesting a connection setup between the T_PCF 150b and the T_AN 160b. In the case where the system has a PCF within each AN, the S_AN 160a takes charge of performing step 44.

In step 45, the T_PCF 150b transmits the A11-BCMCS Registration Request message to the PDSN 140, requesting a connection setup. As described above, if each AN is provided with a PCF, the T_AN 160b transmits the A11-BCMCS Registration Request message to the PDSN 140.

In step 46, the T_PCF 150b transmits the A9-BCMCS Setup Request-A8 message to the T_AN 160b, requesting a connection setup. In step 47, the T_AN 160b transmits the A9-BCMCS Setup Request-A8 Ack message for the A9-BCMCS Setup Request-A8 message to the T_PCF 150b.

In step 48, the PDSN 140 transmits the A11-BCMCS Registration Reply message to the T_PCF 150b, indicating successful reception of the A11-BCMCS Registration Request message.

In step 49, the T_PCF 150b transmits to the S_PCF 150a the A13-BCMCS Connect Request Ack message, indicating successful reception of the A13-BCMCS Connect Request message. The S_PCF 150a transmits the A9-BCMCS Setup Request-A8 Ack message for the A9-BCMCS Request-A8 Ack message to the S_AN 160a in step 467.

In step 470, the AT 170 transmits a BCMCS Flow Registration message for the BCMCS service to the T_AN 160b and then receives the BCMCS contents via the already established A8/A10 connection.

Messages delivered according to the present invention will be described below.

FIG. 5A is a diagram illustrating the format of the A9-BCMCS Request-A8 message transmitted in step 230 of FIG. 2B, step 330 of FIG. 3B, and step 430 of FIG. 4B.

Referring to FIG. 5A, Correlation ID is used for matching with a response message. Sector ID identifies a sector that has received a message from an AT. Security Layer Packet and System Time provide information for authenticating the validity of access channel messages. BCMCS Info indicates a BCMCS service to be prepared over a T_AN. DO Cell Identifier List lists ANs and cells for which BCMCS contents should be set. The fields of the A9-BCMCS Request-A8 message are illustrated in detail in FIGS. 5B through 5K. The illustrated values of the variables in those fields are mere examples and thus the present invention is not limited to the specific details.

FIG. 6A illustrates an example of the A9-BCMCS Request-A8-Ack message transmitted in step 235 of FIG. 2B, step 335 of FIG. 3B, and step 435 of FIG. 4B. Referring to FIG. 6A, Cause indicates whether the A9-BCMCS Request-A8 message has been received normally. The fields of the A9-BCMCS Request-A8 Ack message are identical to their counterparts illustrated in FIG. 5A except that A9 Message Type is set to indicate the A9-BCMCS Request-A8 Ack message and Cause is configured as illustrated in FIG. 6B.

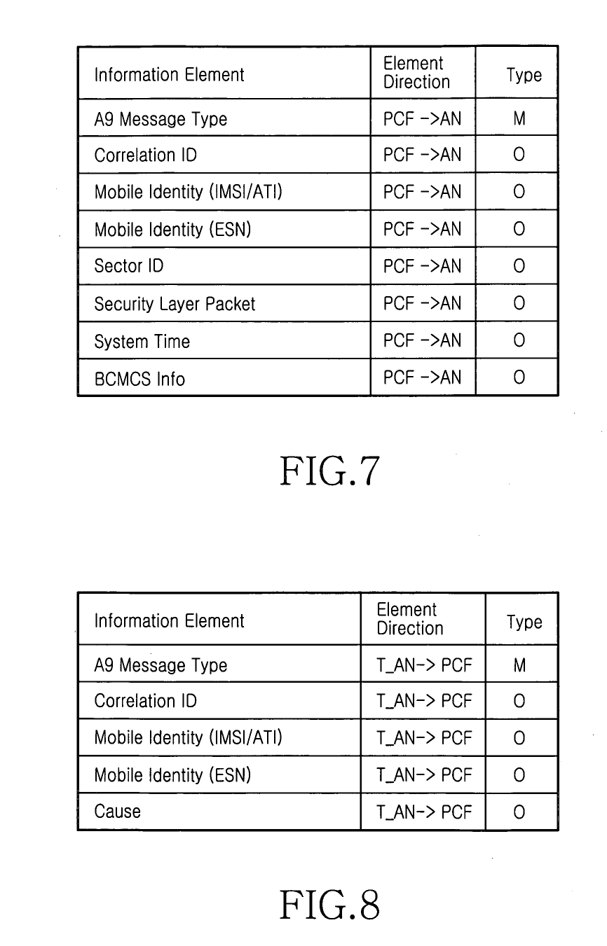

FIG. 7 is a diagram illustrating an example of the A9-BCMCS Setup Request-A8 message transmitted in step 260 of FIG. 2B, step 360 of FIG. 3B, and step 460 of FIG. 4B. The fields of the A9-BCMCS Setup Request-A8 message are illustrated in detail in FIGS. 5B through 5I.

FIG. 8 is a diagram illustrating an example of the A9-BCMCS Setup Request-A8 Ack message transmitted in step 265 of FIG. 2B, step 365 of FIG. 3B, and step 465 of FIG. 4B. The fields of the A9-BCMCS Setup Request-A8 Ack message are identical in configuration to those of the messages illustrated in FIGS. 5A and 6A.

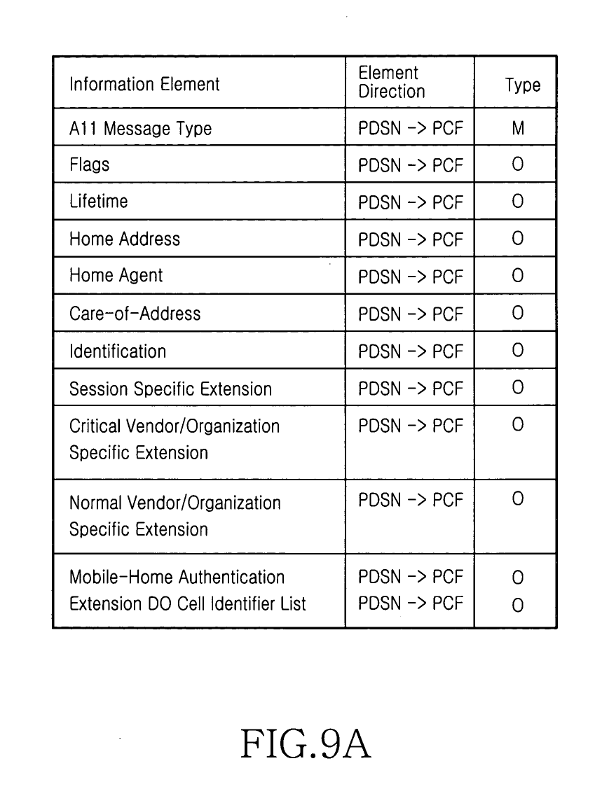

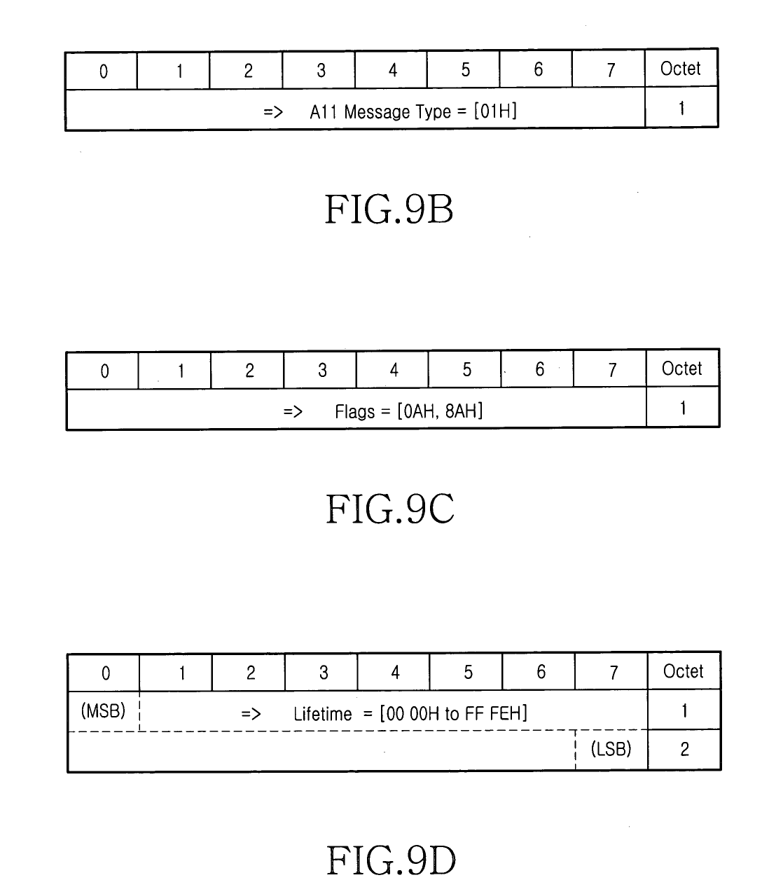

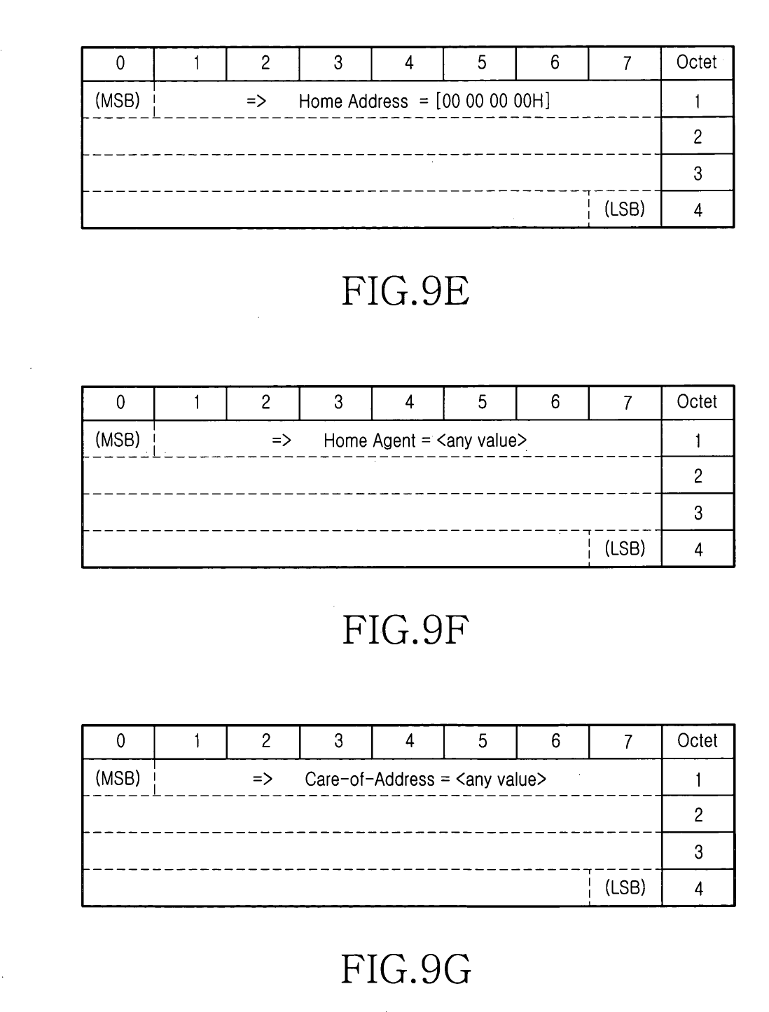

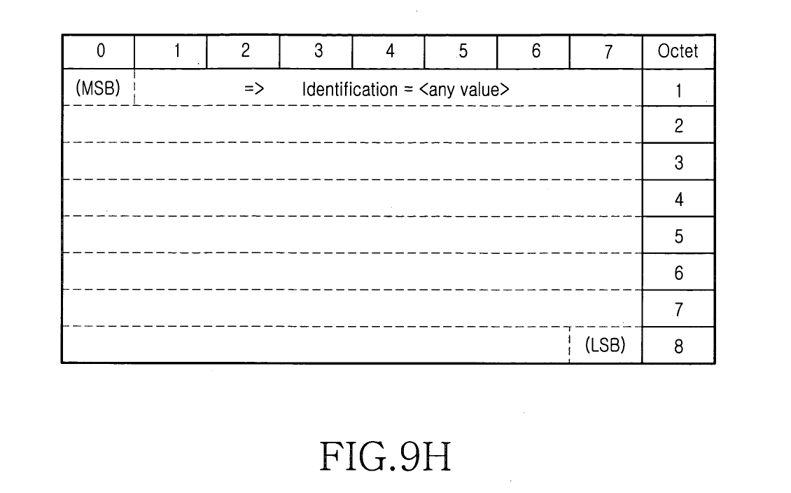

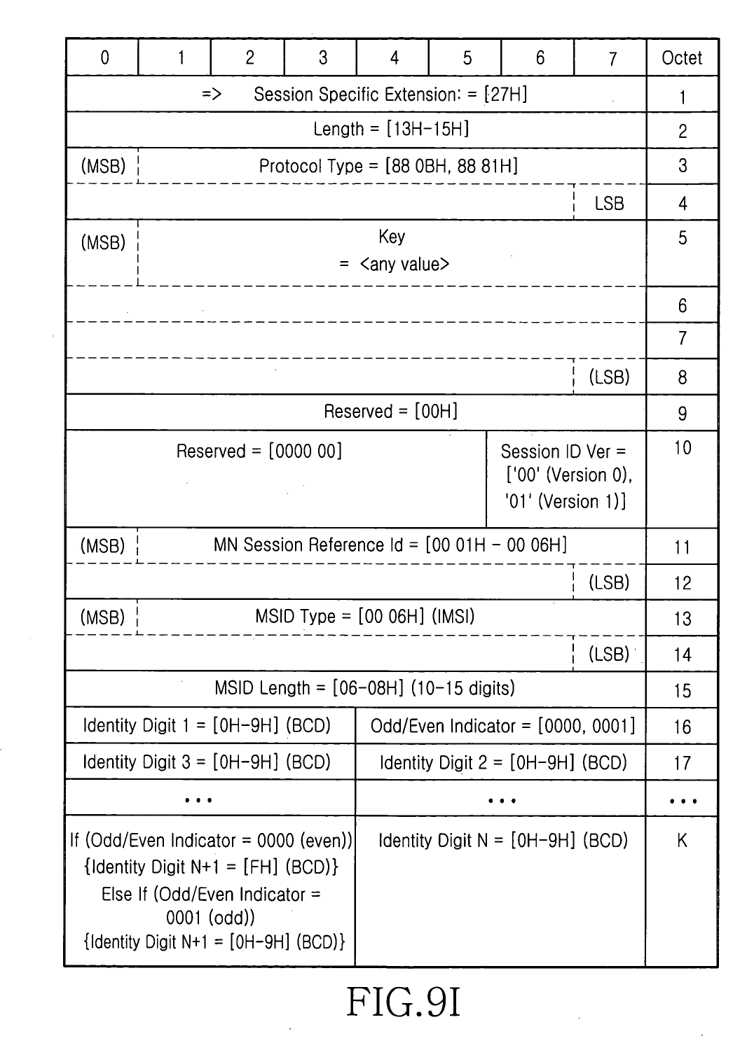

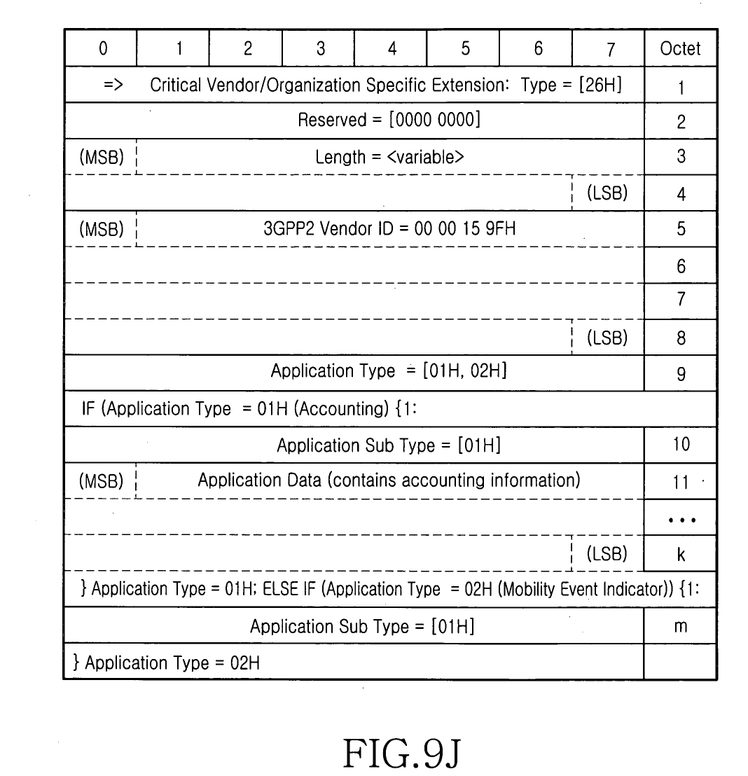

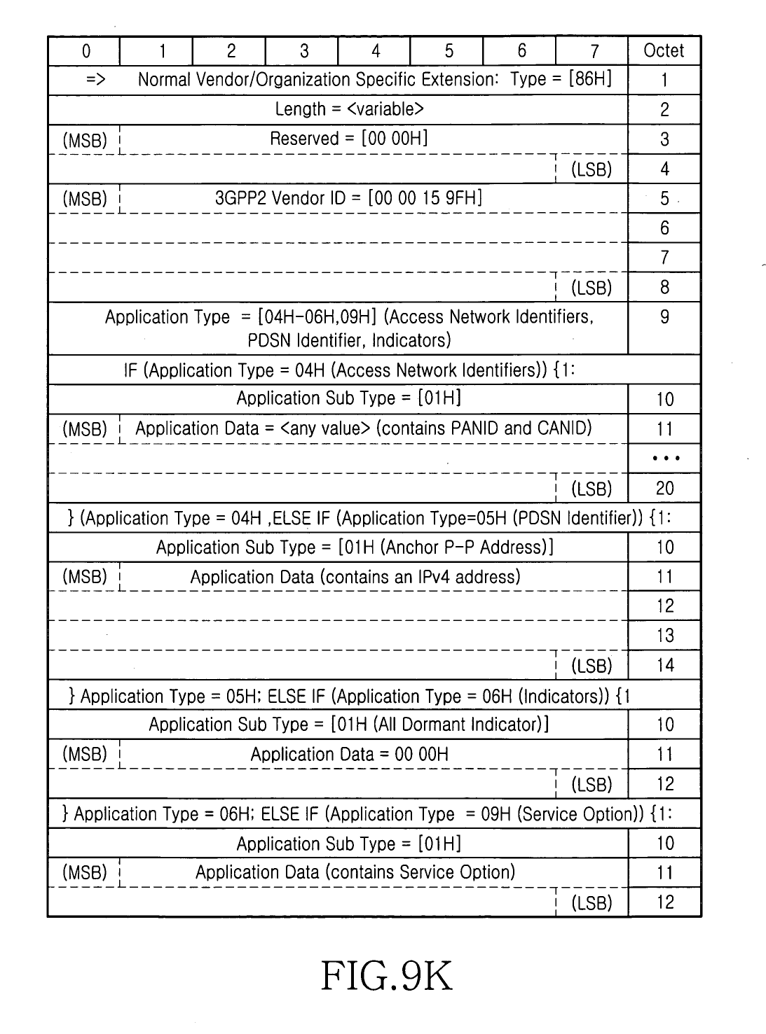

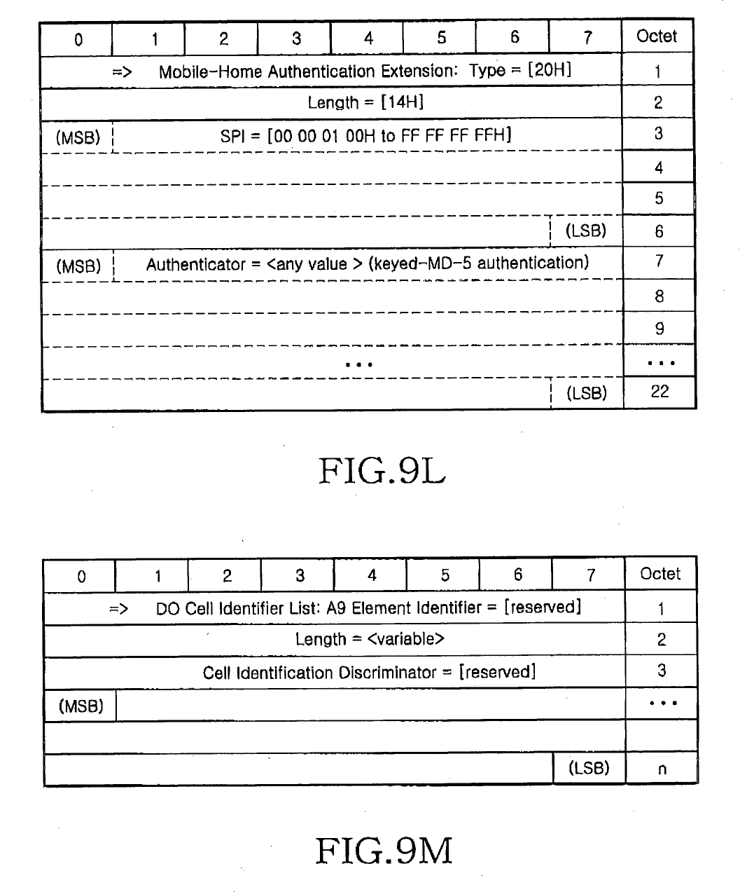

FIGS. 9A to 9M are diagrams illustrating an example of the A11-BCMCS Connect message transmitted in step 350 of FIG. 3B. The fields of the A11-BCMCS Connect message are illustrated in FIGS. 9B through 9M.

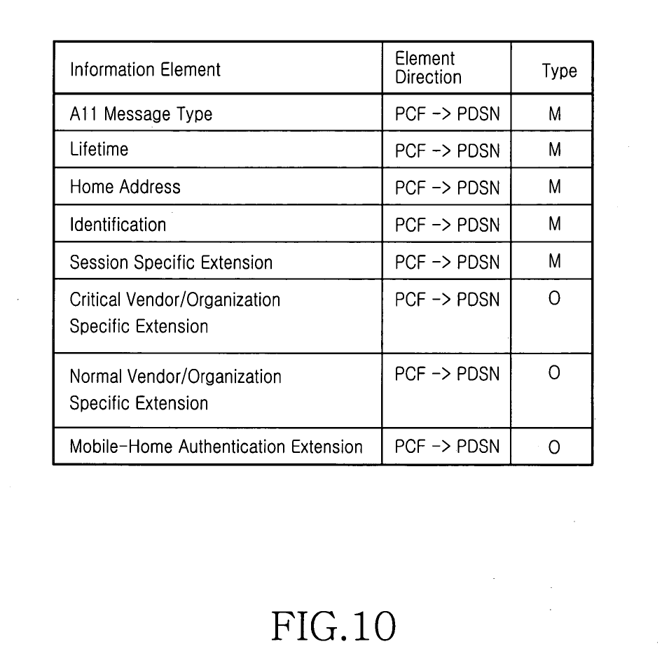

FIG. 10 is a diagram illustrating an example of the A11-BCMCS Connect Ack message transmitted in step 355 of FIG. 3B.

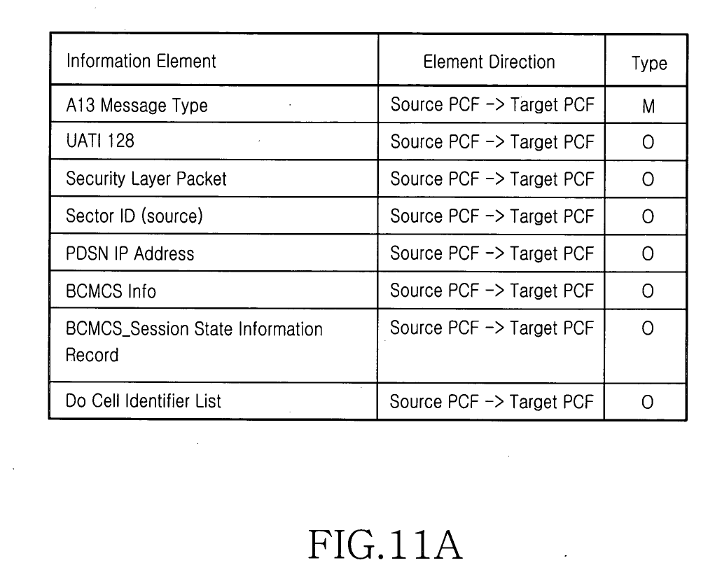

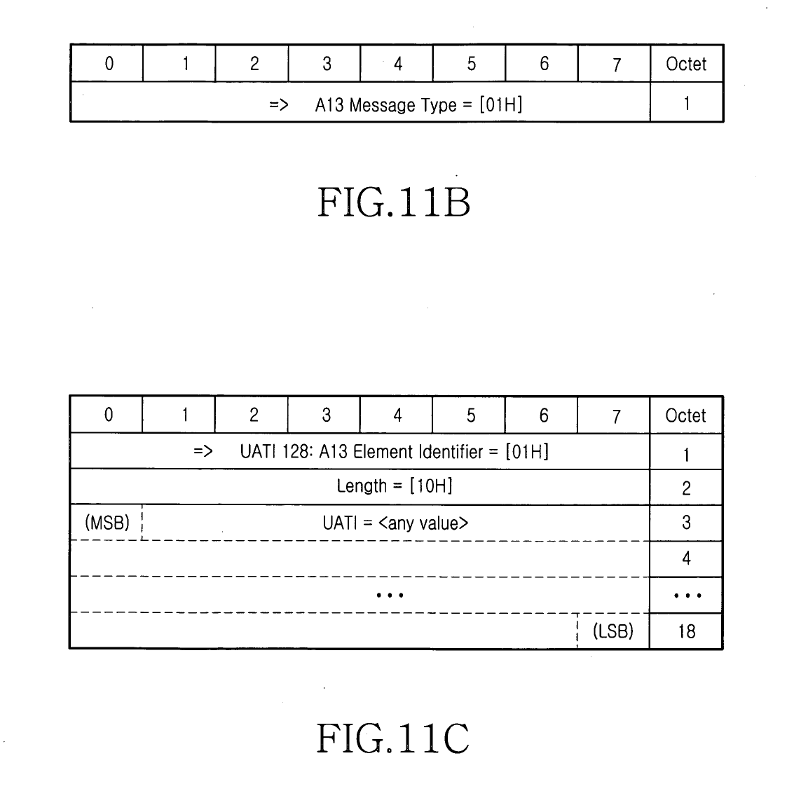

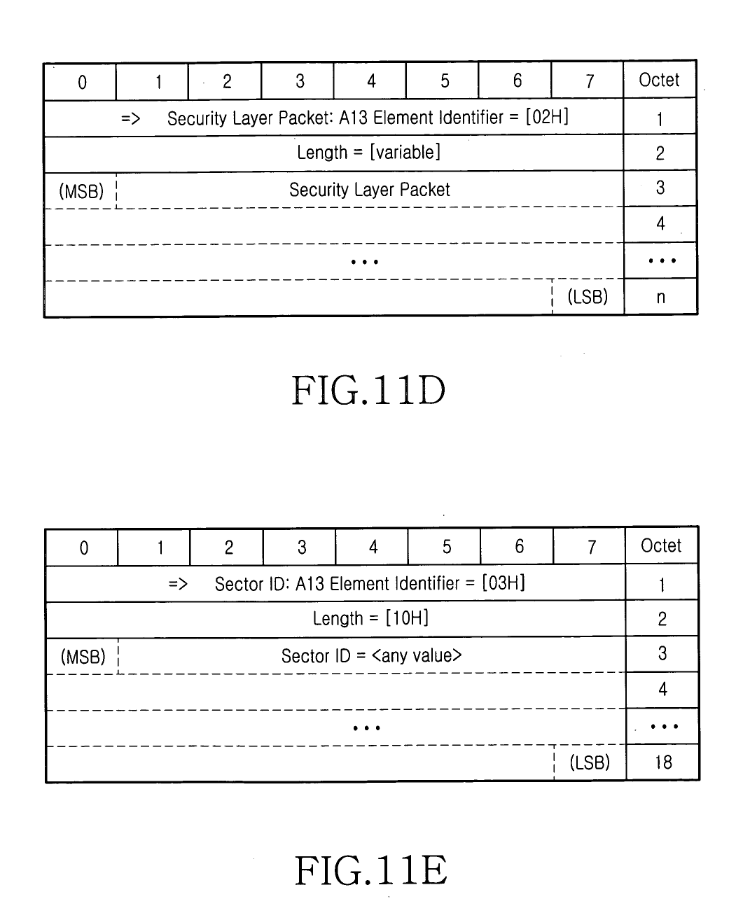

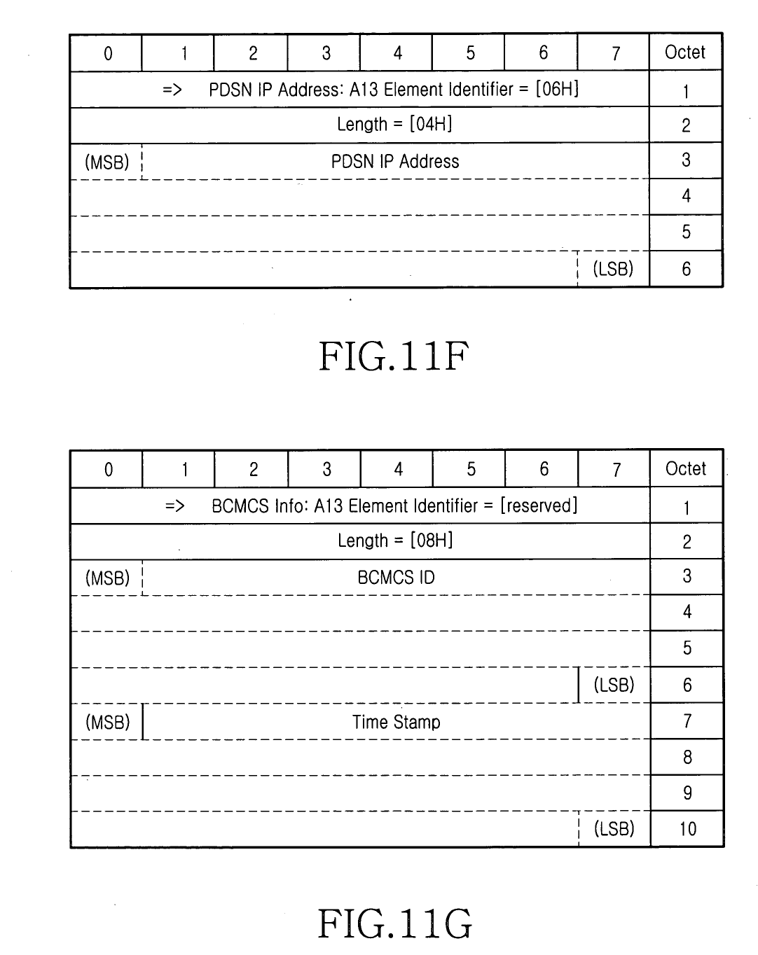

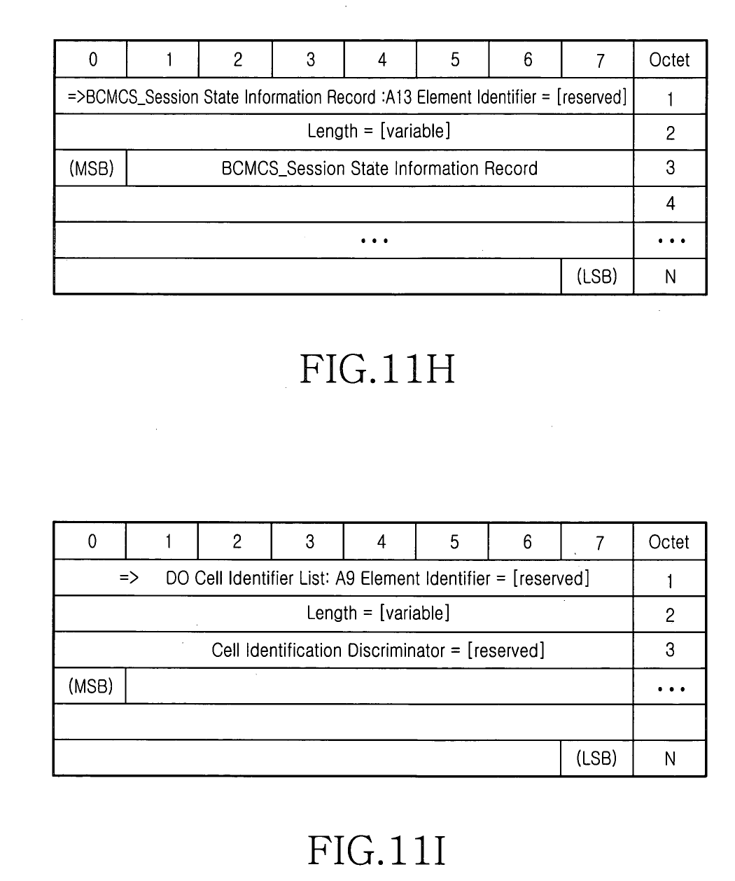

FIG. 11A is a diagram illustrating an example of the A13-BCMCS Connect Request message transmitted in step 440 of FIG. 4B. The fields of the A13-BCMCS Connect Request message are illustrated in FIGS. 11B through 11I. It includes BCMCS Info to deliver BCMCS contents information from the S_PCF to the T_PCF.

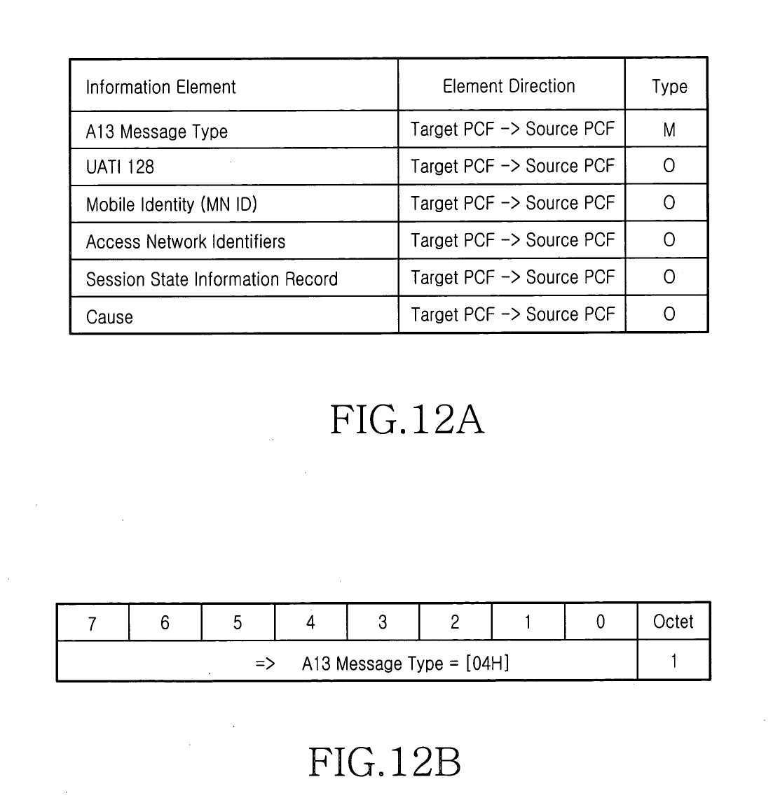

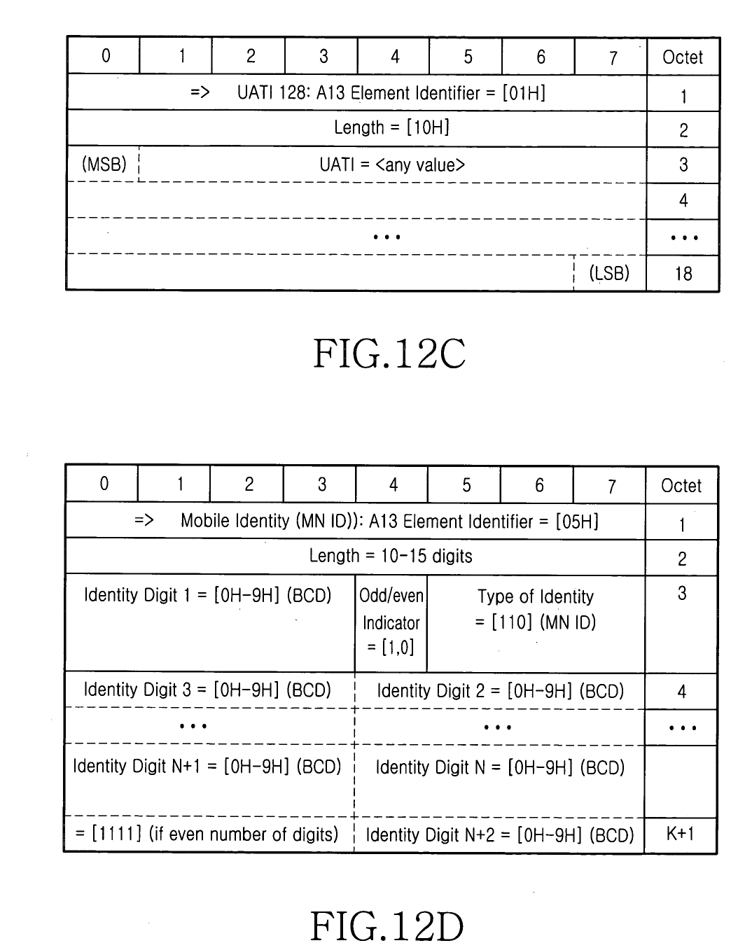

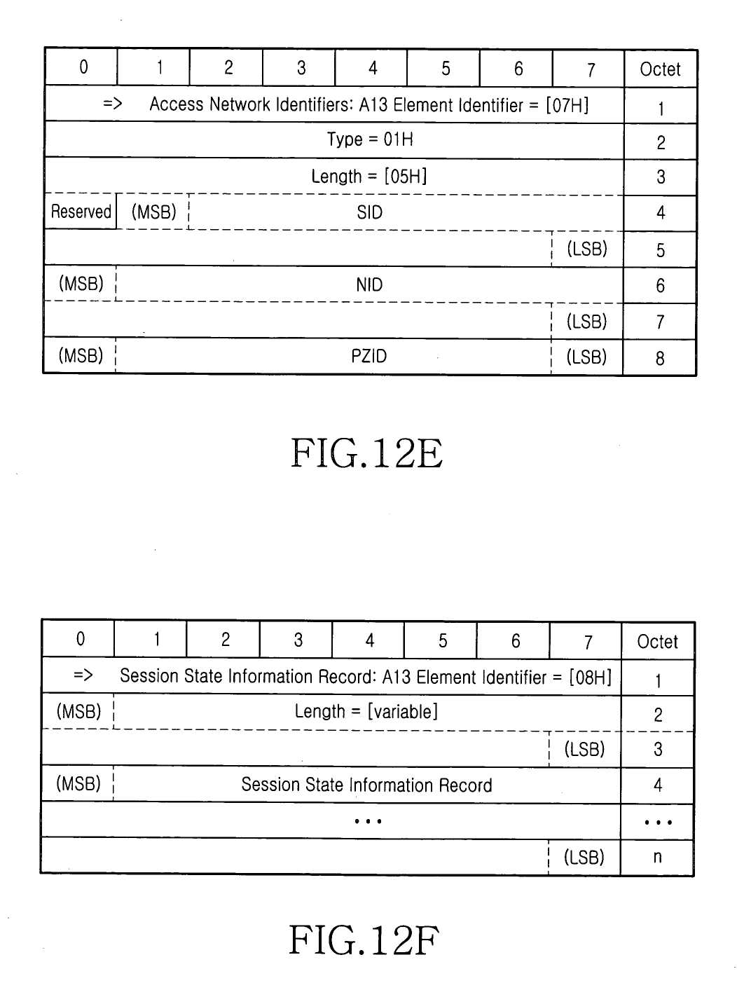

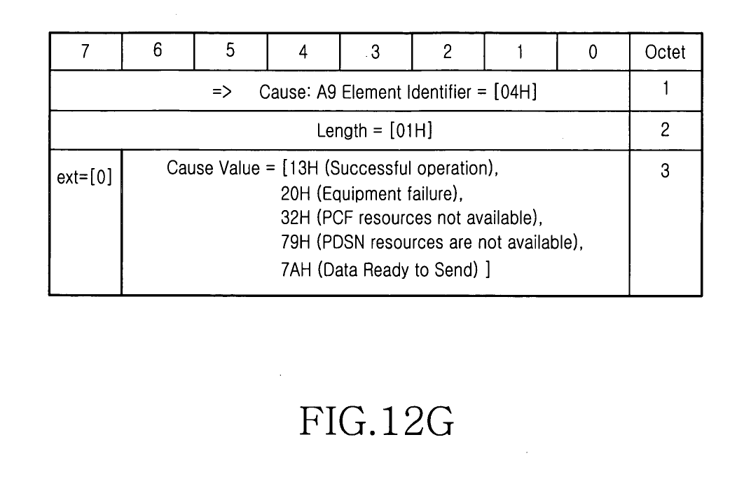

FIG. 12A is a diagram illustrating an example of the A13-BCMCS Connect Request Ack message transmitted in step 445 of FIG. 4B. The fields of the A13-BCMCS Connect Request Ack message are illustrated in detail in FIGS. 12B through 12G.

In accordance with embodiments of the present invention as described above, at a handoff to a new neighboring cell, a user can receive an on-going BCMCS service at the same time in the new cell in a mobile communication system. Therefore, the concurrent reception of the same BCMCS contents from a plurality of cells brings good BCMCS service quality to the user. Also, the user requests BCMS registration in an old cell prior to moving to the new cell. Thus, the BCMCS service is seamlessly provided. The inventive BCMS service providing method at a handoff is applicable to a 1× system or a 1×EV-DO system.

While the invention has been shown and described with reference to certain embodiments thereof, it should be understood by those skilled in the art that various changes in form and details may be made therein without departing from the spirit and scope of the invention as defined by the appended claims.

1. In a mobile communication system including an access terminal (AT) for receiving a BCMCS (Broadcast/Multicast Service) service, a source access network (AN) for providing the BCMCS service to the AT, and a packet control function (PCF) connected to a plurality of ANs, for constructing broadcasting BCMCS service data received from a higher-layer network in the form of packet data, and providing the packet data to a predetermined AN connected to the PCF, a method of implementing a handoff for the AT in the PCF, comprising the steps of:
checking, upon receipt of a handoff request message from the AT through the source AN, the identifier (ID) of at least one of target ANs and the ID of the BCMCS service set in the handoff request message; and
setting up a BCMCS bearer for the BCMCS service with each of at least one of the target ANs, if at least one of the target ANs are included in the ANs connected to the PCF.

2. In a mobile communication system including an access terminal (AT) for receiving a BCMCS (Broadcast/Multicast Service) service, a source access network (AN) for providing the BCMCS service to the AT, and a packet control function (PCF) connected to a plurality of ANs, for constructing broadcasting BCMCS service data received from a higher-layer network in the form of packet data, and providing the packet data to a predetermined AN connected to the PCF, a method of implementing a handoff for the AT, comprising the steps of:
detecting at least one of target ANs that transmit a signal with a strength equal to or greater than a threshold and transmitting to the source AN a handoff request message including the identifier (ID) of at least one of the target ANs and the ID of the BCMCS service by the AT;
transmitting the handoff request message to the PCF by the source AN; and
setting up a BCMCS bearer for the BCMCS service with each of at least one of the target ANs by the PCF, if at least one of the target ANs are included in the ANs connected to the PCF.

3. The method of claim 2, wherein the target AN detecting step further comprises the step of periodically monitoring pilot signals from other ANs by the AT, while receiving the BCMCS service from the source AN.

4. The method of claim 2, further comprising the steps of:
transmitting a BCMCS bearer setup reply message to the PCF by each of at least one of the target ANs after the setup of the BCMCS bearer; and
transmitting a response message for the handoff request message to the source AN by the PCF.

5. The method of claim 2, further comprising the step of simultaneously transmitting the BCMCS data to the source AN and at least one of the target ANs by the PCF after the setup of the BCMCS bearer.

6. In a mobile communication system including an access terminal (AT) for receiving a BCMCS (Broadcast/Multicast Service) service, a source access network (AN) for providing the BCMCS service to the AT, a source packet control function (PCF) connected to a plurality of ANs including the source AN, for providing the BCMCS service to a predetermined AN connected to the source PCF, and a packet data serving node (PDSN) connected to a plurality of PCFs, for constructing BCMCS service data received from a higher-layer broadcasting network in the form of packet data and providing the packet data to a predetermined PCF connected to the PDSN, a method of implementing a handoff for the AT in the PDSN, comprising the steps of:
checking, upon receipt of a handoff request message from the source PCF, the identifier (ID) of at least one of target ANs and the ID of the BCMCS service set in the handoff request message; and
transmitting, if at least one of the target ANs are connected to a target PCF different from the source PCF, a connection request message to the target PCF.

7. In a mobile communication system including an access terminal (AT) for receiving a BCMCS (Broadcast/Multicast Service) service, a source access network (AN) for providing the BCMCS service to the AT, a source packet control function (PCF) connected to a plurality of ANs including the source AN, for providing the BCMCS service to a predetermined AN connected to the source PCF, and a packet data serving node (PDSN) connected to a plurality of PCFs, for constructing BCMCS service data received from a higher-layer broadcasting network in the form of packet data and providing the packet data to a predetermined PCF connected to the PDSN, a method of implementing a handoff for the AT, comprising the steps of:
detecting at least one of target ANs that transmit a signal with a strength equal to or greater than a threshold and transmitting to the source AN a handoff request message including the identifier (ID) of at least one of the target ANs and the ID of the BCMCS service by the AT;
transmitting the handoff request message to the source PCF by the source AN;
transmitting, if at least one of the target ANs are not included in the ANs connected to the source PCF, the handoff request message to the PDSN by the source PCF;
transmitting to a target PCF connected to the target AN a connection request message for connection to at least one of the target ANs by the PDSN; and
setting up a BCMCS bearer for the BCMCS service with each of at least one of the target ANs by the PDSN.

8. The method of claim 7, wherein the target AN detecting step comprises the step of periodically monitoring pilot signals from other ANs by the AT, while receiving the BCMCS service from the source AN.

9. The method of claim 7, further comprising the steps of:
transmitting a BCMCS bearer setup reply message to the target PCF by each of at least one of the target ANs after the setup of the BCMCS bearer;
transmitting a BCMCS connection reply message to the PDSN by the target PCF;
transmitting a response message for the handoff request message to the source PCF by the PDSN; and
transmitting a response message for the handoff request message to the source AN by the source PCF.

10. The method of claim 7, further comprising the step of simultaneously transmitting the BCMCS data to the source AN and at least one of the target ANs by the PDSN after the setup of the BCMCS bearer.

11. In a mobile communication system including an access terminal (AT) for receiving a BCMCS (Broadcast/Multicast Service) service, a source access network (AN) for providing the BCMCS service to the AT, a packet control function (PCF) connected to a plurality of ANs, for providing the BCMCS service to a predetermined AN connected to the source PCF, and a packet data serving node (PDSN) connected to a plurality of PCFs, for constructing BCMCS service data received from a higher-layer broadcasting network in the form of packet data and providing the packet data to a predetermined PCF connected to the PDSN, a method of implementing a handoff for the AT, comprising the steps of:
detecting at least one of target ANs that transmit a signal with a strength equal to or greater than a threshold and transmitting to the source AN a handoff request message including the identifier (ID) of at least one of the target ANs and the ID of the BCMCS service by the AT;
transmitting the handoff request message to a source PCF connected to the source AN by the source AN;
transmitting, if at least one of the target ANs are not included in the ANs connected to the source PCF, the handoff request message to a target PCF connected to at least one of the target ANs by the source PCF;
requesting a BCMCS service registration to the PDSN by the target PCF; and
setting up a BCMCS bearer for the BCMCS service with each of at least one of the target ANs by the target PCF.

12. The method of claim 11, wherein the target AN detecting step comprises the step of periodically monitoring pilot signals from other ANs by the AT, while receiving the BCMCS service from the source AN.

13. The method of claim 1 1, further comprising the steps of:
transmitting a BCMCS bearer setup reply message to the target PCF by each of at least one of the target ANs after the setup of the BCMCS bearer;
transmitting a BCMCS connection reply message to the source PCF by the target PCF; and
transmitting a response message for the handoff request message to the source AN by the source PCF.

14. The method of claim 11, further comprising the step of simultaneously transmitting the BCMCS data to the source AN and at least one of the target ANs by the PDSN after the setup of the BCMCS bearer.

15. A mobile communication system for implementing a handoff comprising:
a source access network (AN) adapted to provide a Broadcast/Multicast Service (BCMCS) service;
a packet control function (PCF) adapted to connect to a plurality of ANs, construct broadcasting BCMCS service data received from a higher-layer network in the form of packet data, and provide the packet data to a predetermined AN connected to the PCF; and
an access terminal (AT) adapted to receive the BCMCS service, detect a at least one of target ANs that transmit a signal with a strength equal to or greater than a threshold and transmit to the source AN a handoff request message including the identifier (ID) of at least one of the target ANs and the ID of the BCMCS service, transmit the handoff request message to the PCF by the source AN, and set up a BCMCS bearer for the BCMCS service with each of at least the target ANs by the PCF, if the target AN is one of the ANs connected to the PCF.

16. The system of claim 15, wherein the AT is further adapted to periodically monitor pilot signals from other ANs, while receiving the BCMCS service from the source AN.

17. The system of claim 15, wherein the AT is further adapted to transmit a BCMCS bearer setup reply message to the PCF by each of at least one of the target ANs after the setup of the BCMCS bearer, and transmit a response message for the handoff request message to the source AN by the PCF.

18. The system of claim 15, wherein the AT is further adapted to simultaneously transmit the BCMCS data to the source AN and at least one of the target ANs by the PCF after the setup of the BCMCS bearer.
